(19) United States
(12) Patent Application Publication
(10) Pub. No.: US 2002/0001110 A1
(43) Pub. Date: Jan. 3, 2002

(54) HOLOGRAPHIC LIGHT PANELS AND FLAT PANEL DISPLAY SYSTEMS AND METHOD AND APPARATUS FOR MAKING SAME

(76) Inventors: MICHAEL H. METZ, YORKTOWN HEIGHTS, NY (US); NICHOLAS J. PHILLIPS, LOUGHBOROUGH (CA); ZANE COLEMAN, MABLETON, GA (US); JOHN H. CAULFIELD, CORNERSVILLE, TN (US); CARL FLATOW, OCEANSIDE, NY (US)

Correspondence Address: HOPGOOD, CALIMAFDE,, KALIL, AND JUDLOWE, 60 EAST 42ND STREET, NEW YORK, NY, 10165

(21) Appl. No.: 08/885,646

(22) Filed: Jun. 30, 1997

Related U.S. Application Data
(63) Continuation of application No. 08/812,381, filed on Mar. 5, 1997, now abandoned.
(63) Continuation-in-part of application No. 08/636,688, filed on Apr. 23, 1996, now abandoned.
(63) Continuation of application No. 08/375,069, filed on Jan. 19, 1995, now abandoned.
(63) Continuation of application No. 07/095,748, filed on Sep. 11, 1987, now abandoned.
(63) Continuation of application No. 08/594,715, filed on Jan. 31, 1996, now Pat. No. 5,822,089.
(63) Continuation-in-part of application No. 08/546,709, filed on Oct. 23, 1995, now Pat. No. 5,710,645.
(63) Continuation of application No. 08/373,878, filed on Jan. 17, 1995, now abandoned.
(63) Continuation of application No. 08/011,508, filed on Jan. 29, 1993, now abandoned.
(63) Continuation of application No. 08/597,491, filed on Feb. 2, 1996, now abandoned.
(63) Continuation-in-part of application No. 08/394,470, filed on Feb. 27, 1995, now Pat. No. 5,974,162.
(63) Continuation-in-part of application No. 08/394,470, filed on Feb. 27, 1995, now Pat. No. 5,974,162.
(63) Continuation-in-part of application No. 08/198,988, filed on Feb. 18, 1994, now abandoned.

(51) Int. Cl. G03H 1/10; G02B 5/32; G02F 1/1335

(52) U.S. Cl. 359/10; 359/15; 349/62

(57) ABSTRACT

An illumination panel for illuminating an object, comprising a substrate, a light diffractive grating and a light source. The substrate is made from an optically transparent material having first and second areal surfaces disposed substantially parallel to each other and a light input surface for conducting a light beam into the substrate. The light diffractive grating is mounted to the first areal surface and has a slanted fringe structure embodied therein for diffracting the light beam falling incident thereto, along a first diffractive order of the slanted fringe structure. The light source produces a light beam for transmission through the input surface and direct passage through the substrate to the slanted fringe structure so as to produce an output light beam of areal extent that emerges from either the first or second areal surface along the first diffractive order, for use in illuminating an object. A spatial-intensity modulation panel can be mounted to the illumination panel to form a color image display device. In the illustrative embodiments, the light diffractive grating is a volume hologram that is pixelated and spectrally-tuned in order to carry out spectral filtering functions within the color image display device.

### RELATED CASES

This application is a Continuation of Copending U.S. appliaction Ser. No. 08/812,301 filed Mar. 5, 1997, which is a Continuation-in-Part of: co-pending US application Ser. No. 08/636,688 filed Apr. 23, 1996 which is a continuation of U.S. application Ser. No. 08/375,069 (now abandoned) which is a continuation of U.S. application Ser. No. 07/095,748 (now abandoned); copending application Ser. No. 08/594,715 filed Jan. 31, 1996, which is a continuation of U.S. application Ser. No. 08/546,709 filed Oct. 23, 1995; co-pending application Ser. No. 08/594,715 filed Jan. 31, 1996, which is a continuation-in-part of co-pending application Ser. No. 08/546,709 filed Oct. 23, 1995, which is a continuation of U.S. application Ser. No. 08/373,878 filed Jan. 17, 1995, which is a continuation of application Ser. No. 08/011,508 filed Jan. 29, 1993 (now abandoned); co-pending U.S. application Ser. No. 08/597,491 filed Feb. 2, 1996, which is a continuation-in-part of copending application No. 08/394,470 filed Feb. 27, 1995, which is a continuation-inpart of application Ser. No. 08/394,470 filed Feb. 27, 1996 which is a continuation-in-part of application Ser. No. 08/198,988 filed Feb. 18, 1994 (now abandoned); wherein each said application is commonly owned by Imedge Technology, Inc. and incorporated herein by reference in its entirety.

### BACKGROUND OF INVENTION

1. Field of Invention

The present invention relates to holographic light panels (HLPs) embodying edge-lit and steep reference angle holograms, for use in illuminating electronically-switched pixelated display screens (e.g., liquid crystal displays), flat panel displays, as well as transparencies and other holograms, and also to methods of making such holographic light panels and the holograms embodied therein.

2. Brief Description of the Prior Art

Many objects, such as transparencies or flat panel displays, require a broad area illumination source. Prior art optical schemes for achieving such illumination typically requires considerable packaging volume, can involve multiple optical elements, are costly and/or inefficient. Manufacturers of flat panel displays, and in particular active matrix liquid crystal displays (AMLCD's), strive for system designs which produce bright, uniform illumination, are thin, lightweight, inexpensive, and energy efficient. Energy efficiency is particularly important for portable displays, such as in notebook computers, to conserve battery life.

For backlighting flat panel displays, various direct lighting solutions at the rear of the display have been used, such as tubular or serpentine fluorescent lamps disclosed in U.S. Pat. Nos. 5,285,361 and 5,280,371, leaky woven fiber optic materials and electroluminescent panels. Backlighting with flat fluorescent lamps is not attractive because of problems with uniformity of light from the tubes and because the tubes are relatively bulky and require too much electrical power for the typical LCD environment (see e.g., Hathaway, Proc. SID 1991, which also describes using a wedge light pipe). Other solutions include variations on the use of edge-lit light pipe or waveguiding structures, textured structures and diffusers are disclosed in U.S. Pat. Nos. 5,359,691; 5,349,503; 5,339,179; 5,335,100; 5,303,322; 5,288,591; and 5,280,372).

An additional problem with displays such as AMLCD's is that in order to spatially intensity modulate light from the backlighting system, a pixelated array of the discrete liquid crystal elements is surrounded by opaque interstitial regions which reflect and/or absorb light incident thereon. Most lighting solutions flood the entire display, both transmissive windows and opaque interstices, with light, thus wasting typically around 50% of the available light, which is lost to the opaque interstices.

Furthermore, many color flat panel displays employ a subpixel array of “absorptive-type” red, green, or blue filters made from absorptive-type pigments and dyes, which spectrally filter spatial intensity modulated “white” light produced from the backlighting system, thus allowing only a small portion of the input light to actually be transmitted through the filters to the LCD layer. Absorptive color filters are used for each subpixel to select the appropriate color bandwidths (red, blue or green) for that pixel from the white light illuminating the pixels. This process is very inefficient and typically absorbs most of the incoming light, requiring stronger illumination light sources, and, in battery operated systems, wasting precious battery life.

Some of these problems have been addressed by proposing solutions involving holographic optical elements (HOEs). For example, in UK Patent Application number GB 2 260 203A, Webster suggests the use of an edge-lit optical waveguide system comprised of an edge-lit holographic light panel comprising a pixelated transmission-type modulated hologram mounted onto a transparent substrate having the same refractive index as the hologram. The hologram has recorded within it repeated sequences of discrete light diffractive gratings arranged in an array, where each discrete grating is arranged to couple a fraction of the incident light within a particular wavelength to a subpixel of an electrically addressable spatial intensity light modulation panel representative of the color of subpixel of the multicolor display. While in theory this prior art holographic light panel design provides advantages over prior art displays employing absorptive-type color filters, it suffers from a number of shortcomings and drawbacks.

First, the light diffractive transmission gratings employed in this prior art light panel exhibit significant objectionable dispersion of the incoming light, whereas in such an application strong wavelength selectivity would be more desirable. Additionally, the illumination light must necessarily make multiple bounces within the substrate, resulting in significant efficiency loss. The accuracy required of the incoming light for it to bounce correctly along the substrate and couple into the hologram is very difficult to achieve in commercial practice, making the holographic light panel impractical.

Thus, there is a great need in the art for an improved holographic light panel that can be used in various backlighting and frontlighting applications, while avoiding the shortcomings and drawbacks of prior art holographic light panel systems.

### Objects And Summary Of The Invention

Accordingly, it is a primary object of the present invention to provide an edge-lit holographic illumination or light panel (HLP) which can be used in a diverse range of backlighting and frontlighting applications while avoiding the shortcoming and drawbacks of prior art holographic light panel systems.

A further object of the present invention is to provide a holographic light panel for producing a pixelated pattern of illumination for use in monochromatic or color display applications.

A further object of the present invention is to provide a method of making such a holographic light panel in which an array of spectrally-tuned, narrow-band volume holograms are embodied for carrying out spectral filtering functions.

A further object of the present invention is to provide a flat panel display system, in which an edge-lit holographic light panel is used to illuminate its electrically-addressable pixelated spatial intensity modulation (SLM) panel.

A further object of the present invention is to provide such a flat panel display system, in which the holographic light panel is realized as a grazing incidence, single-pass reflection-type volume hologram of either the transmission or reflection type.

A further object of the present invention is to provide a method of making such a holographic flat panel display system.

A further object of the present invention is to provide a holographic light panel which has no inherent structure to produce undesirable moire effects when used in image display applications.

A further object of the present invention is to provide a holographic light panel, in which a light beam transmitted through its substrate at a grazing incidence angle is diffracted with a high degree of diffraction efficiency along its first diffractive order.

A further object of the present invention is to provide a holographic light panel which allows a significant reduction in the physical volume necessary for the illumination of flat panel displays, transparencies, holograms, and various other objects.

A further object of the present invention is to provide a holographic light panel, wherein the light entering the panel at a very steep angle is redirected by a slanted-fringe volume hologram to be emitted over a wide area.

A further object of the present invention is to provide a holographic light panel, wherein a large area illumination source is created and contained within a thin package.

A further object of the present invention is to provide a flat panel image display system, in which a holographic light panel of the present invention is provided for backlighting the electrically-addressable spatial intensity modulation panel thereof.

A further object of the present invention is to provide a flat panel image display system, in which a holographic light panel of the present invention is provided for frontlighting the electrically-addressable spatial intensity modulation panel thereof.

A further object of the present invention is to provide a novel system and method for recording holographic light panels of the present invention.

These and other objects of the present invention will be described in greater detail hereinafter.

### BRIEF DESCRIPTION OF THE DRAWINGS

In order to more fully understand the Objects of the Present Invention, the following Detailed Description of the Illustrative Embodiments should be read in conjunction with the accompanying Drawings, wherein:

FIG. 1A is a schematic diagram illustrating the use of a reflection-type holographic light panel of the present invention to illuminate a light transmissive object, such as a film structure, in a “back-lit” manner;

FIG. 1B is a schematic diagram showing the use of a reflection type holographic light panel of the present invention to illuminate a light reflective object, in a “front-lit” manner;

FIG. 1C is a schematic diagram showing the use of a transmission-type holographic light panel of the present invention to illuminate a light transmissive object, in a back-lit manner;

FIG. 1D a schematic diagram showing the use of a transmission type holographic light panel of the present invention to illuminate a light reflective object, in a front-lit manner;

FIG. 2 is a schematic diagram showing the use of a holographic light panel of the present invention to illuminate the liquid crystal display (LCD) screen of a notebook computer;

FIG. 3 is a schematic diagram showing an illustrative embodiment of the flat panel type image display system embodying a holographic light panel of the present invention;

FIG. 4A is a schematic diagram showing an expanded view of the flat panel display system of FIG. 3 and the reflection-type holographic light panel “backlighting” system employed therein;

FIG. 4B is a schematic diagram showing an expanded view of the flat panel display system of FIG. 3 and the transmission type holographic light panel “frontlighting” system employed therein;

FIG. 5A is a schematic diagram showing a system for recording a transmission-type edge-lit hologram (panel) according to the principles of the present invention;

FIG. 5B is a schematic diagram showing a system for recording a reflection-type edge-lit hologram (panel) according to the principles of the present invention;

FIG. 6 is a schematic diagram showing a system for replaying a reflection-type edge-lit hologram constructed in accordance with the principles of the present invention;

FIG. 7 is a schematic diagram showing a system for replaying a reflection-type edge-lit hologram of the present invention, using the conjugate of the original reference wave as the reconstruction beam;

FIG. 8 is a schematic diagram showing a system for replaying a transmission-type edge-lit hologram of the present invention;

FIG. 9 is a schematic diagram showing a system for replaying a reflection-type edge-lit hologram of the present invention in the transmission mode;

FIG. 10 is a schematic diagram showing a system for recording a pixelated reflection-type edge-lit hologram using a one-step recording process according to the present invention;

FIGS. 11 and 12 are schematic diagrams showing the pixelated output of the reflection-type edge-lit hologram of a holographic light panel during replay (i.e. reconstruction);

FIG. 13A is a schematic diagram showing a first system for recording a pixelated transmission-type edge-lit hologram using a one-step recording process according to the present invention;

FIG. 13B is a schematic diagram showing an alternate system for recording a pixelated transmission-type edge-lit hologram using a one-step recording process according to the present invention;

FIGS. 14 and 15 are schematic diagrams showing the output of a flat panel display system embodying a transmission-type edge-lit hologram projecting pixelated light output through an electrically-addressable spatial light intensity modulation panel;

FIG. 16 is a schematic diagram of a system for recording a transmission-type Hi hologram using a light masking (i.e. spatial filtering) object;

FIG. 17 is a schematic diagram of a system for recording an H2 reflection edge-lit hologram by replaying the Hi of FIG. 16, using the image thereof as the object for the H2 hologram of the present invention;

FIG. 18 is a schematic diagram of a system for recording an H2 transmission edge-lit hologram by replaying the H1 of FIG. 16, using the image thereof as the object for the H2 hologram of the present invention;

FIG. 19A is a schematic diagram of a system for recording of the red-subpixel regions of an RGB emitting edge-lit reflection-type holographic light panel of the present invention.

FIG. 19B is a schematic diagram of a system for recording the green-subpixel regions of an RGB emitting edge-lit reflection-type holographic light panel of the present invention;

FIG. 19C is a schematic diagram of a system for recording of the blue-subpixel regions of an RGB emitting edge-lit reflection-type holographic light panel of the present invention;

FIG. 20 is a schematic diagram of a system for recording a “steep reference angle” (i.e. grazing incidence) H3 hologram designed to be used with a diverging source of illumination, for illuminating an H2 edge-lit hologram of the present invention;

FIG. 21 is a schematic diagram of a system for replaying the H3 hologram of FIG. 16, wherein the output beam is used to replay the H2 hologram of FIG. 17;

FIG. 22 is a schematic diagram of a system for replaying an H3 hologram that is used to illuminate an H2 edge-lit hologram that emits a pixelated pattern of broad-band illumination;

FIG. 23 is a schematic diagram of a system for recording an H2 transmission-type edge-lit hologram designed for illuminating a black and white (e.g. grey-scale) pixelated display panel; and

FIG. 24 is a schematic diagram of a system for replaying the H2 transmission-type edge-lit hologram of FIG. 23, and producing a pixelated pattern of white light.

### DETAILED DESCRIPTION OF THE ILLUSTRATIVE

### EMBODIMENTS OF THE INVENTION

Referring now to the accompanying Drawings, the Illustrative Embodiments of the Present Invention will now be described in detail, wherein like structures in the FIGS. shall be indicated by like reference numerals.

Brief Overview of Holographic Light Panel Hereof

The present invention is directed to a novel device capable of producing a plane of unpatterned or patterned (e.g., pixelated) light of a specified spectral distribution (e.g., broad-band, narrow-band, etc.), for use in various types of illumination applications. In general, the device comprises at least one volume diffractive optical element, and an optically transparent substrate for supporting the same. The function of the optically transparent substrate is to receive a light beam produced from a light source, and to directly transmit the received light onto the volume diffractive element in a single-pass manner, at a very steep, grazing incidence angle (i.e., greater than the critical angle for the material, and typically approaching 90 degrees to the normal to the face of the device).

In general, the volume holograms incorporated in the holographic light panels (HLPs) hereof contain fringes which are neither parallel to the large area boundary surfaces of the holographic material as in standard reflection holograms, nor are perpendicular thereto as in standard transmission holograms. Rather, the fringes are ‘slanted’ with respect to the aforementioned boundary surfaces. With respect to some embodiments of the present invention, terms “substrate referenced”, “edge-lit” or “edge-illuminated” hologram shall be used herein to describe holograms with slanted fringe structures whose recording reference beams as well as playback reconstruction beams pass at an angle nearly parallel to the plane of the hologram, with respect to the holographic medium, usually passing first through a substrate associated with the hologram, prior to entry into the hologram. This angle is greater than the critical angle for the substrate carrying the hologram.

With respect to other embodiments of the present invention, the term “steep reference angle hologram” shall be used to describe holograms where the playback (i.e., reconstruction) beam for the hologram enters the hologram from its air/face surface or where the reconstruction beam passes into a substrate attached to the hologram at a large angle (nearly parallel to the plane of the substrate, but entering via the face, not the edge), at an angle less than the critical angle for the substrate, and then passes from the substrate to the hologram. A steep reference angle hologram usually comprises a thicker package than is achieved with a true substrate referenced, or edge-lit hologram. Steep reference angle holograms can be used in many (though not all) of the applications of edge illuminated holograms, without many of the engineering restrictions imposed by the edge-lit regime necessary to achieve commercially acceptable quality.

While many of the figures shown in the accompanying Drawings depict the light from the light source as entering the optically transparent substrate through its edge (which may or may not be bevelled), it is understood that such light can be made to travel through the substrate at a steep angle via other means, such as by sending it through a prism or diffractive grating affixed to the face of the substrate. Notably, the most of the useful light travelling through the substrate passes out of the substrate and into the hologram directly, without bouncing or waveguiding within the substrate. The function of the volume diffractive optical element is to diffract the transmitted light beam in a manner to produce from the front surface of the holographic light panel, either plane of patterned (e.g., pixelated) or unpatterned light of a specified spectral distribution. Hereinafter, the term “holographic light panel”, “HLP”, or “light panel” shall be used to describe such a device, whereas the term “hologram” shall be used to describe the volume diffractive optical element used in the holographic light panel, even though it may have been created by non-holographic means.

In a typical configuration, the holographic light panel will approximate a rectangular parallelopiped, comprised of four edges and two faces having larger surface areas. The light entering the holographic light panel interacts with the hologram embodied therein, and is then re-emitted in a controlled pattern from the face of the device, creating the appearance that the face of the holographic light panel is a new light source. Within the hologram there is a fringe pattern consisting of variations in refractive index of the enabling medium (e.g., polymer material, gelatin, etc.). The structure of the slanted fringes constituting the hologram control the emitted light pattern. In some embodiments, two or more consecutive holograms may be used to achieve the desired emitted light pattern.

In general, the holographic light panels of the present invention are thin, flat, and inexpensive to manufacture, and can produce a plane of unpatterned or patterned (i.e., pixelated) light from a broad surface area. The plane of unpatterned or patterned light can be “white” light, multi-colored, or monochromatic light, depending on spectral and temporal composition of the light entering the edge of the holographic light panel. The unpatterned light emitted from the holographic light panel will have an intensity distribution which is contiguous over the spatial extent (x,y) of its light emitting surface, whereas patterned light will have an intensity distribution which varies thereover in order to satisfy the requirements of any specific application to which the present invention is applied.

In other embodiments of the present invention, the holographic light panel can be designed to produce a light beam or multiple light beams which can be narrow, highly directed or wide angle or even diffused within a controlled emission angle. As will be described in greater detail hereinafter, such holographic light panels can be used anywhere broad areal illumination is desired or required. Examples of such applications include, but are certainly not limited to: the conversion of standard holograms into edge-lit holograms; flat-panel type image displaying systems; fingerprint and footprint image detection systems; biological-tissue image detection systems; access-control systems; and the like.

Construction of A Basic Configuration of The Holographic Light Panel

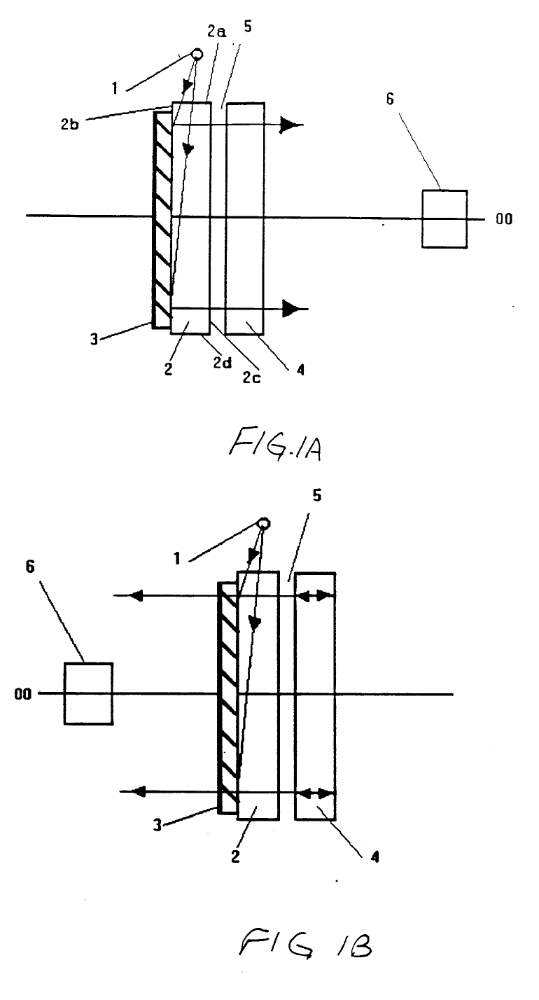

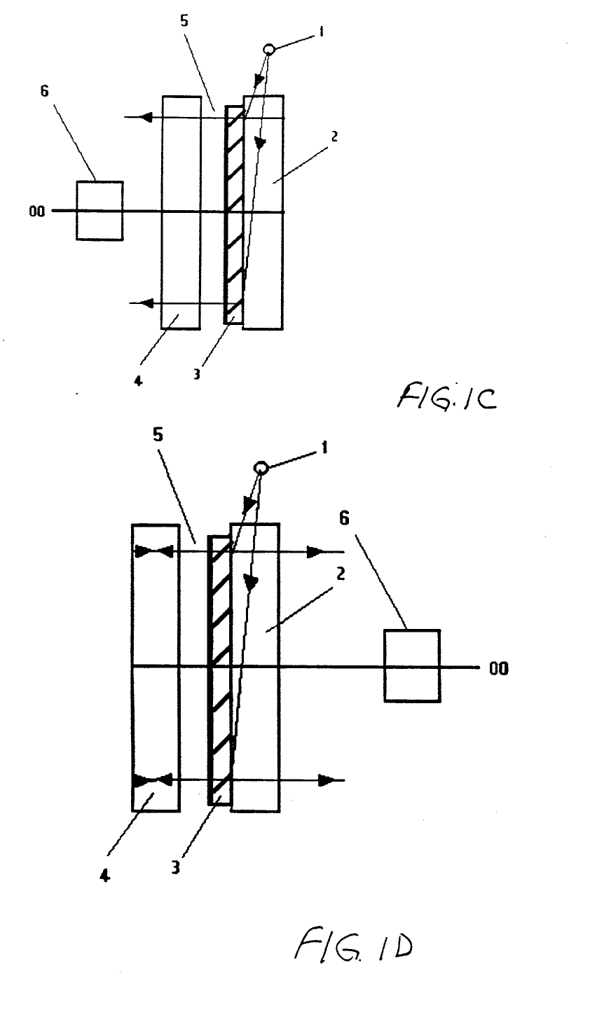

FIG. 1A shows a basic configuration of the HLP incorporating a reflection-type slanted fringe hologram, and used with a transmissive object, such as a liquid crystal display panel. Light from light source 1, is caused to travel through a very thin substrate 2 at an angle greater than the critical angle for substrate 2. Substrate 2 is typically an optically transparent material such as glass or plastic. Substrate 2 contains edge surfaces 2a and 2d and face surfaces, 2b and 2c . In FIG. 1A, the light is depicted illuminating the edge 2a of substrate 2. The edge 2a is usually polished to achieve high transmission of the source light through the substrate. Owing to the geometry of the light source and/or any light conditioning optics associated therewith, the incoming light is aligned so that most of the light rays from light source 1 pass directly through the bulk of the substrate and passing through surface 2b to hologram 3 in a single-pass manner (i.e., without internally reflecting against face surface 2c ). When using incoherent illumination sources and very thin substrates, only a small section of the light beam is used. Consequently, the wavefront curvature will approximate a plane, rendering the hologram less sensitive to the wavefront, chromaticity or location of the incoming light source.

Hologram 3, containing a previously recorded slanted fringe pattern, diffracts light reaching it from light source 1, redirecting the light in the general direction of object 4, thus illuminating object 4 with a predetermined light pattern dependent on the fringe structure recorded in hologram 3. Object 4 may be, for example, a transmissive flat panel display, a transparency, another hologram, etc. Object 4 may be in direct contact with substrate 2, or optically coupled by an intermediate layer such as an adhesive, or an index matching fluid, or object 4 may merely be sufficiently proximate to substrate 2 to achieve a proper amount of illumination of object 4 to allow its intended performance. Note that the light emitted from the hologram may be collimated, converging, or diverging; may have spatial structure, such as pixelation; and may be directed generally perpendicular to the plane of the hologram, or at an angle with respect to the normal to the plane of the hologram, depending on the construction configuration which formed the fringe structure within the hologram. Depending on the application, the space 5 between the object to be lit 4 and the substrate 2 may be filled with air; filled with a material to index-match object 4 to substrate 2 to minimize reflection losses and/or to reduce or eliminate undesirable moire fringes; or non-existent, in the case where object 4 is laminated to or closely pressed against substrate 2. As shown, a viewer or detection system 6 is located on the opposite side of the object from the HLP.

Other configurations of the holographic light panel system are shown in FIGS. 1B, 1C and 1D.

FIG. 1B shows a basic configuration of the HLP comprising a reflection-type slanted fringe hologram, with a reflective object, such as a reflective flat panel display, a reflection-type slanted fringe hologram, a biological specimen, or other type of object. Light from light source 1 travels through substrate 2 at a steep angle, passes into hologram 3, and gets diffracted, to then travel in the general direction of object 4. Light reflected from object 4 travels back through substrate 2 and hologram 3 to viewer or detection system 6, located on the same side of the device as the hologram.

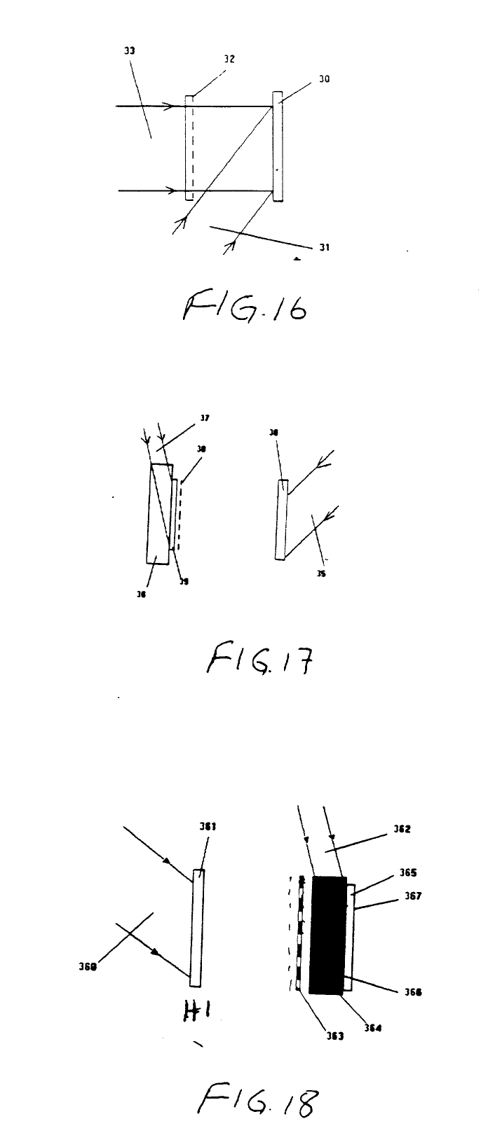

FIGS. 1C and 1D show similar systems, but using a transmission-type slanted fringe hologram instead of the reflection-type slanted fringe hologram of FIG. 16.

The HLP depicted in FIGS. 1A, 1B, 1C and 1D allows for a very thin, compact system packaging, where the light source for the hologram can be located at the base of the hologram or at a location remote from the display. In the case of a remotely located light source, the light could then be routed to the display, for example, via fiber optics and distributed by the hologram for illumination across the object.

Advantages and Uses of the Holographic Light Panel

One advantage of the HLP is that the light exiting therefrom can be shaped to be sent out in small solid angles or large solid angles, and can be contiguous or emitted in discrete areal sections, corresponding to a pattern of such as stripes or dots (pixels).

These discrete light patterns (arranged as stripes or dots) may be monochromatic, or in a pattern of alternating colors, such as red, green and blue triads, or white. This feature can offer several advantages. For example, in an active matrix liquid crystal display (AMLCD) panel, each pixel region is surrounded by opaque interstices which contain electronic components, such as thin-film transistors (TFTs), which control the liquid crystal polarization state for the adjacent light intensity modulation “window”, by either blocking light or allowing light to pass through the window by way of polarization filtering. Prior art backlighting and frontlighting system designs flood the entire surface, windows and interstices with light, wasting considerable light which is blocked by the interstices. In contrast, an HLP as taught herein can direct light in a pixelated pattern so that the light emitted from the hologram is directed only to the windows, and not the opaque interstices, providing a significant improvement in the light transmission efficiency of the overall holographic light panel.

In addition, the pixelated pattern of light emitted by the hologram need not be monochromatic, but rather can be made, as described herein, polychromatic such as an alternating red, green, blue light pattern. This is achieved by forming individual spectrally-tuned holograms at the subpixel regions of the holographic light panel, which spatially correspond to the actual subpixel structure of an electrically addressable spatial light modulation panel (e.g., AMLCD). Such a colored (red, blue, green) illuminator can be used to improve the efficiency and reduce the cost of manufacture of flat panel displays such as active matrix liquid crystal displays. In addition, the holograms can polarize incoming light, thus diminishing or eliminating the need for a separate polarizer in the spatial-intensity modulation component of an image display system.

In one embodiment of the present invention, a monochromatic electrically addressable spatial light intensity modulating (SLM) panel is used to carry out the spatial intensity modulation function of the image display system by controlled light transmission (or reflection), whereas a RGB pixelated HLP illuminator would carry out the spectral filtering function within the display system by diffractive means. A brightness advantage over current color SLMs by a factor of 10× or more is expected by shaping the light to match the specific pixel size requirements of each display. Additional brightness is expected because the invention will generate color images without the use of absorptive-type spectral filters. Also, as spectral filtering occurs within the holographic light panel, rather than within the spatial intensity modulation panel, there are no red, blue, green (RGB) point failures typically found within in conventional prior art SIM panels.

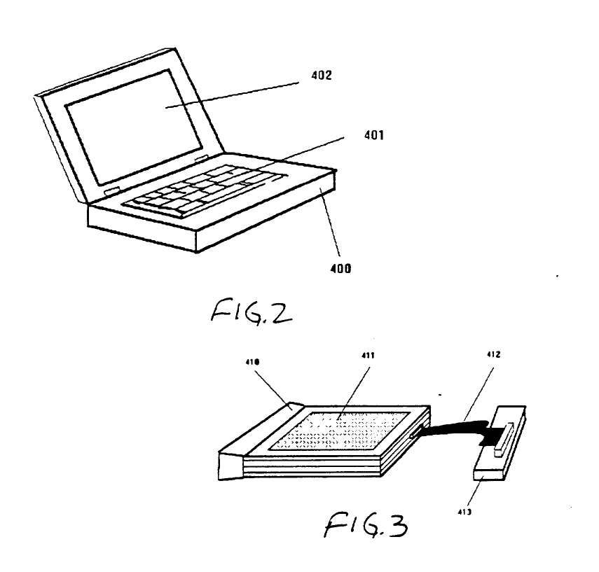

As shown in FIG. 2, the HLP of the present invention can be incorporated within the flat panel display sub-system 402 within a notebook computer system 400. Depending on the application, the HLP of the present invention can be used as either a holographic backlighting or frontlighting panel. As shown in FIG. 3, the flat panel display system comprises a housing 410 embodying a light which illuminates the edge of the HLP device 411 supported within the housing of the display system. The HLP comprises a holographic optical element mounted to an electrically addressable SLM panel (e.g., monochromatic SLM panel), well known in the flat panel display art. Electrical signals used to drive the monochromatic SLM panel are produced by a display controller 413 and transmitted to the SLM panel by way of a cable 412. In general, the monochromatic SLM panel can be realized using various types of enabling technologies found, for example, in active matrix liquid crystal display (AMLCD) panels, and dual-scan LCD panels, both well known in the display art.

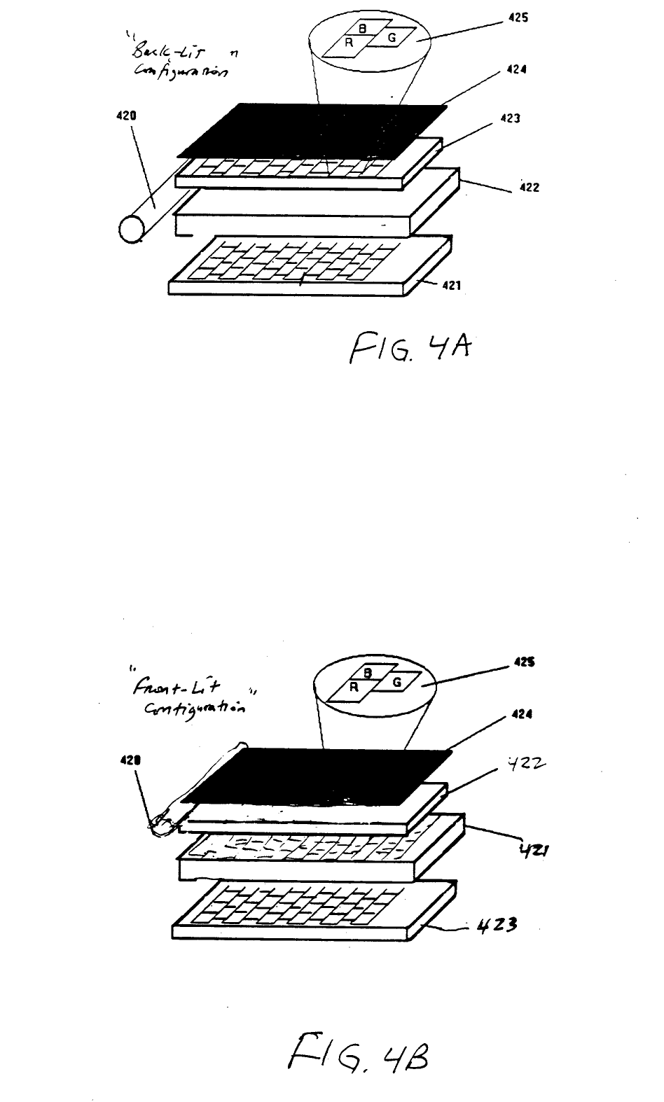

In FIG. 4A, the structure of the flat panel display system hereof is shown in greater detail. While the flat panel display system shown in FIGS. 3, 4A are based on a reflection-type pixelated volume hologram with slanted fringes, it is understood, however, that the display system can be realized using a transmission-type pixelated hologram. As shown in FIG. 4A, the flat panel display system of the illustrative embodiment comprises a number of basic subcomponents, namely: an optically transparent substrate 422; a pixelated volume hologram, 421 optically coupled to the rear surface of the substrate using the index matching principles taught in copending application Ser. Nos. 08/594,715, 08/546,709 and 08/011,508; a monochromatic SLIM panel 423 optically coupled to the front surface of the substrate 422; a light diffusing panel 424 mounted upon the surface of the monochromatic SLM panel 443; and a light source and associated optics 420 mounted closely adjacent the substrate in order to transmit light produced from the light source through an edge of the substrate. While not shown for simplicity of explication, it is understood that the elements such as polarizing filters, glare reduction and color compensation filters may typically be provided within such a system. As illustrated in FIG. 4, the red, green and blue subpixel regions of the pixelated volume hologram 421 are in registration with corresponding subpixel regions of the monochromatic SLM panel disposed on the opposite side of the light transmitting substrate. The structure of the reflection-type pixelated volume hologram 421 will be described in greater detail hereinafter.

During operation of the flat panel display of FIG. 4, light rays produced from light source and associated optics 420 enter the substrate 422 (either through its edge or face by way of refractive or diffractive elements), and travel through therethrough at a near grazing incidence angle into the pixelated reflection-type hologram 421. Light rays striking the pixelated hologram which meet the prerecorded Bragg condition (i.e., typically light rays that have travelled through the substrate without bouncing—direct transmission and travelling at the appropriate angle) are diffracted into the first diffractive order. In the flat panel color image display system of shown in FIG. 4, the light rays emerging from pixelated reflection hologram 421 form a contiguous field of discretely projected light beams, comprising alternating spectral bands corresponding to the additive primary colors “red”, “green” and “blue”, as shown in magnified inset 425. By virtue of such wavelength-selective diffraction, carried out by the array of the multiple-slanted fringe reflection holograms, spectral filtering occurs within the pixelated HLP of the display system, and not within the monochromatic SLM panel. Notably, the diffracted light rays emerge from each of the reflection holograms (within the array) at or nearly perpendicular to the broad area surfaces of the planar substrate, pixelated hologram, and monochromatic SLM panel.

Thereafter, these diffracted light rays travel again through the substrate 422, and thence through the monochromatic LCD panel where they are spatial intensity modulated on a subpixel by subpixel basis in order to impart graphic information thereonto in a conventional manner for subsequent display in either the direct or projection mode. The diffracted light rays within the red spectral band are transmitted through the corresponding “red pixel” windows of the monochromatic LCD panel; the diffracted light rays within the “green” spectral band are transmitted through the corresponding “green pixel” windows of the monochromatic LCD panel; and the diffracted light rays within the “blue” spectral band are transmitted through the corresponding “blue pixel” windows of the monochromatic LCD panel. As the light from the pixelated hologram hereof produces linearly polarized light that has been spectrally filtered in accordance with a pixelated spatial filter pattern, it is possible to use a monochromatic SLM panel having one linear polarizer (i.e., the analyzer), in contrast with two linear polarizers required by conventional panels. This aspect of the present invention will result in a marked decrease in manufacturing costs of the system.

The function of the optional light diffusing panel 424 is to control the angle of spread (field of view) of the emitted light, and/or to depixelate the light produced from the discrete pixels of the monochromatic SLM 423. It also increases the transmission efficiency of the panel and increases image contrast as observed off-axis. As a result, the sensation of seeing discrete dots displayed from the display panel is lessened or eliminated, and display brightness and image fidelity increased.

In FIG. 4B, the structure of the front-lit, flat panel display system hereof is shown in greater detail. While the flat panel display system shown in FIGS. 3, 4A and 4B are based on a reflection-type pixelated volume hologram with slanted fringes, it is understood, the display system of FIG. 4B is realized using a transmission-type pixelated hologram. It is understood that such a back-lit system can also be realized using reflection-type hologram of the present invention. As shown in FIG. 4B, the flat panel display system of the illustrative embodiment comprises a number of basis subcomponents, namely: an optically transparent substrate 422; a pixelated volume hologram 421 optically coupled to the rear surface of the substrate using the index matching principles taught in copending application Ser. Nos. 08/594,715, 08/546,709 and 08/011,508; a monochromatic LCD panel 423 optically coupled to the rear surface of the hologram 421; a light diffusing panel 424 mounted upon the front surface of the substrate 422; and a light source and associated optics 420 mounted closely adjacent the substrate in order to transmit light produced from the light source through an edge of the substrate. As illustrated in FIG. 4B, the red, green, and blue subpixel regions of the pixelated volume hologram 421 are in registration with corresponding subpixel regions of the monochromatic SIM panel disposed on the opposite side of the light transmitting substrate. The structure of the transmission-type pixelated volume hologram 421 will be described in greater detail hereinafter.

In general, there are several different ways in which to fabricate the pixelated (reflection or transmission) holograms incorporated into the HLP-based color display systems of the present invention.

According to a first illustrative recording method, a single master hologram is made in which the pattern of red, green and blue spectral filtering diffraction regions are realized therein.

According to a second illustrative recording method, a two separate master holograms are made, where in the first hologram, the pattern of red and green and blue spectral filtering diffraction regions are realized therein during the first stage of the mastering process; and where in the second hologram, the pattern of blue spectral filtering diffraction regions are realized therein during the second stage of the mastering process. Once made, copies of these pixelated holograms are spatially registered and then optically and mechanically coupled together by way of lamination or other suitable techniques.

According to a third illustrative recording method, three separate master holograms are made, where in the first master hologram, the pattern of red spectral filtering diffraction regions are realized therein during the first stage the mastering process; where in the second hologram, the pattern of green spectral filtering diffraction regions are realized therein during the second stage of the mastering process; and where in the third hologram, the pattern of blue spectral filtering diffraction regions are realized therein during the third stage of the mastering process. Once made, copies of these pixelated master holograms are properly registered and optically and mechanically coupled together by way of lamination or other suitable techniques.

Details of such holographic recording processes will be described hereinafter.

Procedures for Making “Non-Pixelated” HLPs

Procedures for making non-pixelated HLP devices will now be described in detail. While construction of HLP holograms as described herein follows basic well-known holographic principles, the primary difference between the construction of the HLPs hereof and standard holograms resides in use of strict index matching volume techniques taught in Applicants copending U.S. application Ser. Nos. 08/594,715, 08/546,709 and 08/011,508. As disclosed in said copending Applications, Applicants have developed a technique for index matching the substrate to the recording medium when the index of refraction of the substrate is less than the recording medium (referred to as Case 1), and another technique for index matching when the index of refraction of the substrate is greater than (or equal to) the recording medium (referred to as Case 2).

Index matching Case 1

In U.S. application Ser. Nos. 08/594,715, 08/546,709 and 08/011,508, Applicants teach that for Case 1 recording situations, the highest quality edge-lit holograms can be achieved by carefully matching the index of refraction of the recording medium with the index of refraction of its associated substrate. The degree of matching required is a function of the steepness of the reference beam angle and the light transmission into the recording medium, which is derived by combining the well known Fresnel reflection equations with Snell's Law at the substrate-recording medium interface. In practice, the best index matching in this case is achieved by choosing a substrate whose index of refraction is equal to or slightly less than the index of refraction of the recording medium. For example, in accordance in with this index matching technique, Applicants have discovered that BK10 glass works well with DuPont holographic recording material designated HRF 352. The concept works well with any well-matched substrate and recording medium. Typically, Applicants have found that it is desirable to maintain the mismatch in indices of refraction between the substrate and the recording medium to less than 0.02 for angles of incidence of the recording reference beam greater than 80 degrees where a relatively high light transmission efficiency is required. If an intermediate layer, such as a glue or an index matching fluid, is used between the recording medium and the substrate, then care must be taken to select the index of refraction of the intermediate layer to be either: equal to the substrate, or equal to the recording medium, or between the index of refraction of the recording medium and the substrate.

Due to the steep angles used in the recording process of the HLP, the optical path length in the material is comparatively quite long compared with standard holographic geometries. This means that the quality of the final hologram is more significantly affected by the size of the scattering centers within the recording medium, and thus, Applicants have found that better results are achieved when using low scatter recording materials such as the family of DuPont holographic recording photopolymers.

Index Matching Case 2

In U.S. application Ser. Nos. 08/594,715, 08/546,709 and 08/011,508, Applicants also teach that for Case 2 recording situations, it is best to use a “gradient-type” index matching region at the interface between the substrate and the recording medium. This type of indexing matching region can be achieved during the recording of edge illuminated holograms when using photopolymer recording materials which contain migratory monomers. During such recording process, applicants have discovered that under particular conditions the action of the signal wave (object beam) can increase the refractive index of the recording layer near the boundary between the recording material and the substrate by attracting migratory monomer toward this boundary. This increases the ability of the reference wave to couple into the recording medium when it is incident at an angle close to grazing incidence. At locations of high reference signal strength in the recording medium, the refractive index increases in that locality, thus enabling the penetration of the reference wave.

Systems for making Edge-Lit HLPs

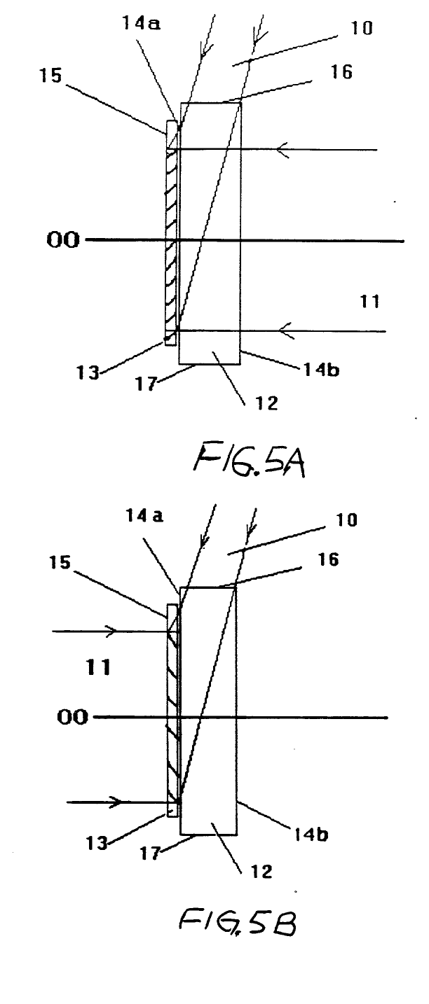

The recording system shown in FIG. 5A can be used to record transmission-type grazing incidence volume holograms under Case 1 and Case 2 recording conditions. The recording system of FIG. 5B can be used to record reflection-type grazing incidence volume holograms under Case 1 and Case 2 recording conditions. The primary difference between these two recording systems is that in the system of FIG. 5A, the object beam 11 enters the recording medium on the same side that the reference beam enters the recording medium, whereas in the system of FIG. 5B, the object beam enters the recording medium on the opposite side that the reference beam enters the recording medium.

In each of the holographic recording systems shown in FIGS. 5A and 5B, a recording medium 13, which typically is in sheet or liquid form, is laminated or otherwise optically and mechanically attached or adhered to an optically transparent substrate 12, such as sheet of glass or plastic. Reference beam 10 and object beam 11 must be derived (i.e., produced) from the same laser source in order to ensure coherency. The reference beam 10 is introduced into substrate 12 at a large grazing angle, typically between 80 and 90 degrees to optical axis 00. Reference beam 10 may be introduced through edge 16 of substrate 12, or through a face surface, 14a or 14b, via refractive or diffractive means, such as a prism, diffraction grating or hologram. Edge 16 may be beveled to better enable introduction of the reference light beam at an appropriate angle. In embodiments of the present invention where very steep or grazing incidence reference beams are used, reference beams with the s-polarization state should be used to achieve acceptable contrast of the interference fringes formed in the recording medium.

Depending on the application, and the desired reconstruction geometry, reference light beam 10 may be collimated, converging, diverging and/or anamorphically shaped so that it may have different properties along each of two perpendicular axes. For example, to make more efficient use of light going into a substrate edge which is long in one dimension and thin in the other, the reference light beam may be collimated in the thin direction and diverging in the long dimension. Reference light beam 10 then passes through substrate 12 and substrate/recording medium interface 14 and into recording medium 13.

During Case 1 recording processes, the relative amount of light from the reference beam that is transmitted into the recording medium depends on the relative refractive indices of the substrate and recording medium, the angle of incidence of the beam, and the polarization state of the beam. Inside the recording medium, reference beam 10 interferes coherently with object beam 11 to form, within recording medium 13, a holographic fringe pattern, with slanted fringes. Notably, each “slanted fringe” formed in the recording medium is the effect of a localized change or modulation in the bulk index of refraction of the recording medium caused by a change in the optical density of the recording medium during the recording process, such changes in optical density of the recording medium are in response to the light intensity pattern created by the interference of the object and reference light beams within the recording medium. The angle of slant of the fringes is typically in the neighborhood of between 35 and 55 degrees to the optical axis of the object beam. Object beam 11 may typically be collimated, converging or diverging light, or may have some other wavefront form. In fact, the object beam may have scattered off of a real object before reaching the recording medium; it may comprise the real image from another previously made hologram; or it may have passed through a mask, diffuser or other optical element, as will be described further below.

In Case 2 recording processes, increasing the refractive index at the interface can be achieved by either reference or signal wave activity. Such an increase can be achieved by, for example, exposing the recording layer to a diffuse page of signal wave (e.g., passing the object beam through a diffusing material) on its own prior to exposure to the holographic patterns. Since monomer will migrate toward the incoming light, the bulk index of the recording layer is thus increased. The bulk index increases because polymer occupies less volume than monomer.

It is noted that signal-wave gated holograms can have zero noise background, since interference patterns are only present where the reference wave is permitted to leak in. This process of index matching by light induced effects throughout the bulk of the recording layers is distinct from localized index matching induced by the evanescent field of the reference wave near the interface between recording medium and substrate. In either method, the effects are to be employed just prior to the recording of the holographic pattern.

After recording of the holographic fringe pattern using either the Case 1 or Case 2 scheme, the recording material is processed to stop the exposure sensitivity, and fix the fringe pattern formed in the recording material. Depending on the processing required for the recording material, it may be necessary to delaminate the recording material from the substrate for processing. For example, materials such as dichromated gelatin and silver halide require wet processing, which may be better achieved by delamination from the substrate, particularly if glass plates coated with gelatin were used, with the gelatin-air surface laminated to substrate 12. Other materials, such as the DuPont photopolymer family, are processed by exposure to ultraviolet light and, optionally, subsequent baking. This process does not require that the recording material be delaminated from substrate 12, however, for cost factors or other reasons, it may be advantageous to use a different substrate for playback than when recording. Other recording materials may require no post-processing at all.

Once a “perfect” hologram (HLP master) has been produced for the monochromatic or color display application, large numbers of low-cost copies can be produced that will have the same properties as the HLP master, thus significantly reducing the manufacturing costs of flat panel displays.

Systems for Replaying Recorded Edge-Lit HLPs

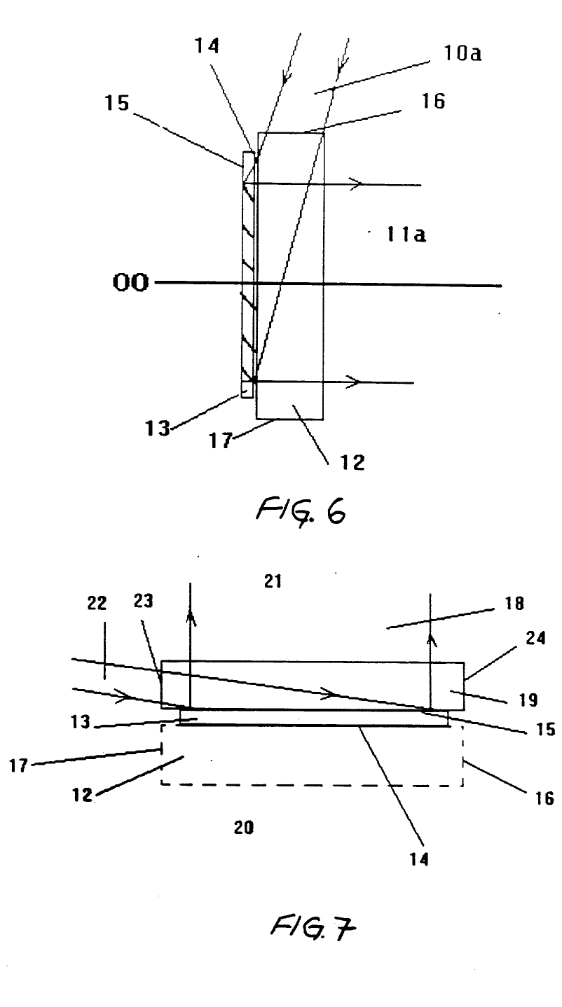

In FIG. 6, a system is shown for replaying the edge-lit hologram recorded using the system of FIG. 5B. Though not necessary always, holograms are typically replayed (reconstructed) using the conjugate of the reference beam. For example, as shown in FIG. 6, the HLP output can be produced after processing of the holographic recording medium, by simply replaying hologram 13 with a replica of the reference beam in the same location as the hologram was constructed. When played back in this configuration, the replay beam 10a passes through substrate 12 into hologram 13, which diffracts the beam into the first diffracted order, producing a replica 11a of object wavefront 11, shown to the right of the hologram in FIG. 6. Alternatively, the replay beam could be transmitted through surface 17 to exit the hologram shown in FIG. 6 through the opposite face of the hologram. For practical reasons, one may want to disattach hologram 13 from recording substrate 12 and reattach it to a different substrate selected because the hologram replay process has less stringent index matching requirements, or the different substrate is less expensive, less breakable, and/or has some other beneficial property or characteristic.

In FIG. 7, a system is shown for carrying out the conjugate replay using a reflection-type pixelated volume hologram. Notably, it is usually desirable for the replay beam to have a wavefront which is conjugate to the wavefront of the reference beam used during recording. As shown in FIG. 7, processed (fixed) reflection-type volume hologram disposed opposite additional substrate 19 is affixed to the opposite side of the recording medium 13. This substrate 19 should have a reasonably good index match to the recording medium, but in many applications the match does not have to be as stringent as during recording, where maintaining a good match in relative intensity of the object and reference beam is important to create high fringe contrast. An inexact index match of the playback substrate will cause the angle of playback to shift, or may cause a shift in the reconstruction wavelength or a change in reconstruction efficiency. For many applications, the cost, weight and non-breakability benefit of using, for example, an acrylic substrate 19 for reconstruction outweigh the disadvantage of an angular shift of the reconstructing beam location. In addition, when selecting a substrate for reconstruction to match reasonably well to the index of refraction of the recording medium, consideration must be given to the fact that processing of the recording medium may swell or shrink the medium, creating a shift in the angle of the recorded fringes. Thus it is important to select the reconstruction substrate material and thickness to optimize the amount of light which will pass from the substrate into the recording medium, along with the reconstruction angle. The reconstruction substrate material should typically have an index of refraction which is less than or equal to the bulk index of refraction of the recorded hologram material, in accordance with Case 1 index matching criteria.

Referring to FIG. 7, it is noted that for best reconstruction, the reconstruction beam 22 would typically be the conjugate of the recording reference beam and if the reference beam was converging, the reconstruction beam is its diverging conjugate. Assuming no swelling or shrinking of the recording medium enters substrate 19 either through edge 23, through the face, or an appropriately angled beveled edge, in a similar manner to what is noted above for the recording process, and thus the reconstructed image of the original object or object beam 18 is formed. Depending on application requirements, the original recording substrate may be retained, removed or replaced. If the original object beam was, for example, collimated light, then by reconstructing with laser light (having a wavelength similar to the recording light) then a collimated area of light will be emitted from the hologram. This hologram, if sufficiently thick, may be reconstructed using white light as well, and will operate as a narrow band filter, in much the way that standard reflection holograms do, but with the additional advantage of having a compact package where the reconstruction beam is not blocked by a viewer or viewing device. Applicants have made HLP devices using 514.5 nm Argon laser light which emit a green area of light when reconstructed with a white light source such as a 20 W Tungsten-halogen lamp. Thus such devices can be thought of as a new, compact areal light emitter, or holographic light panel (HLP).

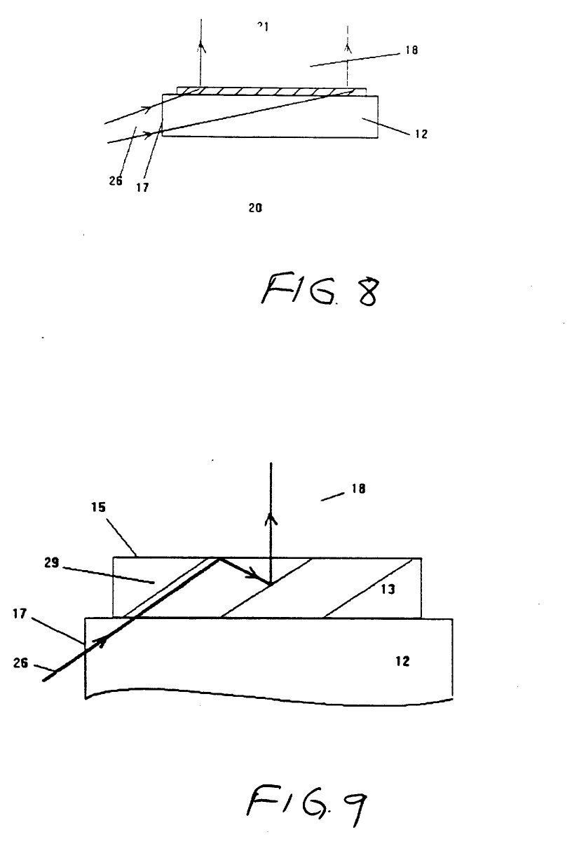

In FIG. 8, a system is shown for carrying out the playback (reconstruction) of a transmission-type slanted-fringe volume hologram, where the reconstruction beam 26 enters the hologram from the opposite side as the emitted beam 18. In this system, Case 1 index matching techniques are carried out with the relaxed criteria used during the playback process, as noted above.

In FIG. 9, an alternative system is shown for reconstructing a transmission-type slanted-fringe volume hologram. This system is based on Applicants' discovery that the HLP hologram can be made so that it can be replayed by sending light through the original substrate 12, or a substitute substrate made from a transparent material such as acrylic as noted above. As illustrated in FIG. 7, reconstruction light enters the substrate from the direction opposite the one it travelled during recording of the hologram, on the same side of the recording material. Thus, in the system of FIG. 7, the reconstructing light source is located along an optical axis that is rotated approximately 180 degrees about the optical axis of the references beam source in the corresponding recording system. As noted above, the reconstruction light may enter the substrate through the edge 17, opposite from edge 16 where the construction light entered, or it may enter the substrate from a face. The light, 26, enters approximately parallel to the direction of the fringes in the hologram, or at such an angle that it passes through the hologram without being strongly diffracted because the Bragg condition is far from being satisfied. As illustrated in FIG. 9, the replay light then bounces off of the air-substrate interface at the other side of the hologram 13 totally internally reflecting off of that interface, and then proceeding back into the hologram at an angle which does satisfy the Bragg condition, thus diffracting and emerging from the hologram as beam or image 18. Applicants shall refer to this technique as the “false replay method” and have achieved significant success using this reconstruction geometry. Since the hologram maintains the properties of a narrow band or ‘notch’ filter, Applicants shall also refer to this HLP hologram as a ‘transmission notch filter’, since reconstructing light and emitted light are on opposite sides of the hologram, as in a standard transmission hologram.

The methods described above are useful for making holographic illuminators which emit an areal field of structured light from their surface. In many applications, such as Grey scale and color flat panel display systems, it is desired that the light emissions from the holographic light panels are segmented, striped, pixelated, or otherwise structured.

Making Pixelated HLPs For Grey-Scale Flat Panel Display Systems

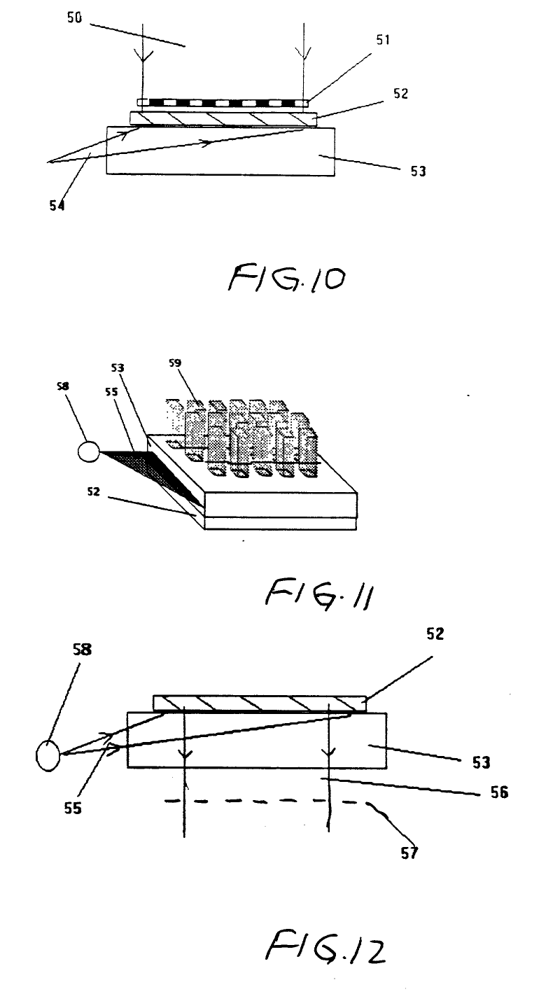

In FIG. 10, a system is shown for recording a reflection-type slanted-fringe HLP for use, for example, in constructing a grey-scale flat panel display system. While the laser source of the system is shown producing a diverging reference beam 54 it is understood, however, that the reference beam may be collimated, converging, or otherwise shaped (e.g., anamorphically), depending on the application. As shown, the reference beam is made to travel through substrate 53 at a very steep or grazing incidence angle, and passes from the substrate 53 into the holographic recording medium 52 in a manner described hereinabove. In order that the light produced from the beams resulting holograms correspond with the subpixels of the monochroms LCD panel used in the flat panel display system, a mask 51 is placed in the optical path of the object beam 50 entering the recording media 52. This mask can be made from any of many known methods, depending on the situation variables, such as pixel size and pattern. For example the mask can be comprised of an array of holes in a metal sheet, or a chrome pattern on glass. As shown, mask 51 is placed proximate to or in contact with the holographic recording medium either directly or via an intermediate transparent spacer. In the case of LCD display applications, the mechanics of the system necessitate that the closest the hologram can be placed to the windows of the LCD is 3 mm. Under those circumstances, a 3 mm spacer would be placed between the mask and the holographic recording material in order that the reconstructed image of the aperture in the mask are aligned directly with the subpixel regions of the LCD. It may be desirable to optically couple the mask, spacer and recording material by, for example, index matching fluid. Using the above-described recording system collimated light from the object beam 50 passes through mask 51 to enter holographic recording medium 52 and interfere with reference beam 54 creating fringes which in the recording medium which are then fixed to become a reflection-type slanted-fringe hologram.

In FIG. 11 is shown for replaying (i.e., reconstructing) the hologram of the HLP for the grey-scale SLM panel display system. In this system, mask 51 is removed and depending on the recording material and application requirements, the hologram 52 may be attached to the original substrate 53 or affixed to a new substrate. As noted above, depending on the desired configuration, the hologram is replayed with a reasonable replica of the wavefront of the original reference beam, or, its conjugate. During replay, replay beam 55 is emitted from light source 58 and may be conditioned by appropriate beam conditioning optics. The conditional replay beam is directed through substrate 53, so that the light passing from the substrate to the hologram 52 will interact with the hologram at or near the Bragg angle for the hologram. As the replay beam is diffracted, the hologram emits a pixelated light pattern 59. As shown in FIG. 11, the pixelated light pattern produced from the HLP corresponds to the original mask pattern used during the holographic recording process of FIG. 10. If the original spatial mask has a series of holes (i.e., light transmitting apertures) corresponding to the subpixel regions of the monochromatic SIM panel in a flat panel display, then discrete areas or shafts of light 59 will be emitted from the holograms and pass precisely through the subpixel regions of the SIM panel (with minimal or no obstruction) for spatial intensity modulation. Alternatively, the hologram of the HLP can be replayed using the techniques including, for example, the ‘transmission notch filter’ or ‘false replay mode’, discussed elsewhere herein.

Surprisingly, Applicants have discovered that the reflection edge-lit holograms hereof can be made sufficiently thick to maintain excellent filtering properties even though the fringes within the hologram are slanted with respect to the plane of the hologram. Thus, in monochromatic LCD systems of type shown in FIG. 11b, white light can be used to replay the pixelated slanted-fringe reflection hologram of the HLP of FIG. 11, and emit a pixelated distribution of light for spatial intensity modulation in a conventional manner.

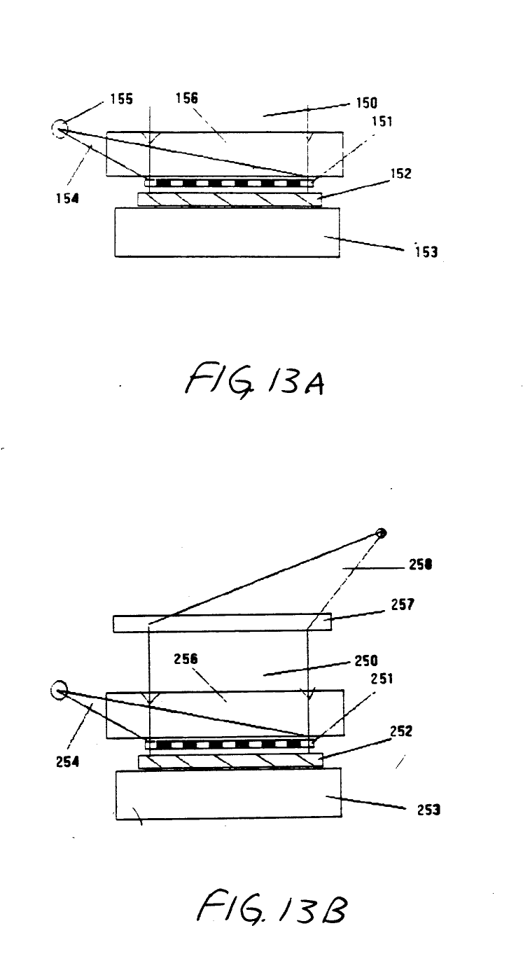

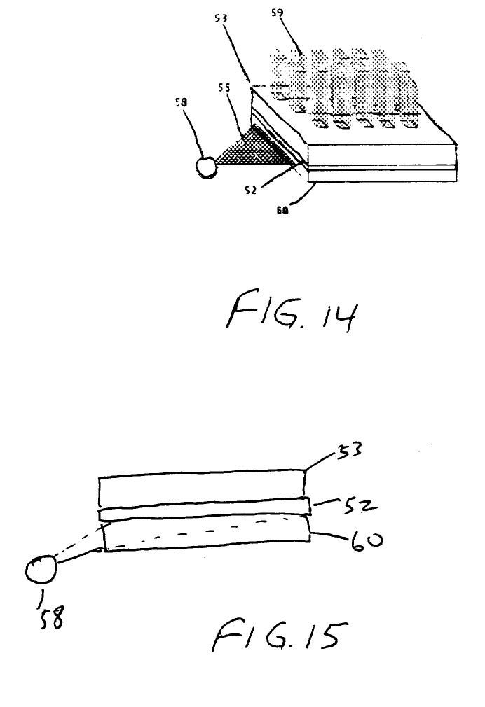

In FIG. 13, a system is shown for recording a transmission-type volume hologram for use in the HLP of a monochromatic flat panel display system according to the present invention. As shown, the recording system comprises a radiation-absorbing substrate 153, upon which a uniform layer of holographic recording medium 152 is mounted. A spatial mask 151 is mounted proximate to the recording medium. The spatial mask has a pattern of apertures corresponding to the subpixel required of the monochromatic LCD panel of the display system. As shown, a light transmitting substrate 156 is placed over the spatial mask during, the recording process diverging laser light 154 from source (55). Enters the substrate and travels directly towards the recording medium 151 and interferes with the object beam 156 which has been spatially modulated by the spatial mask. The interference pattern with the recording medium is then fixed in a conventional manner to produce a transmission volume hologram for use in the HLP of the gray-scale LCD system. In FIGS. 14 and 15, a transmission type HLP is shown integrated within a monochromatic LCD system. As shown, the diverging light 55 produced from source 58 (e.g., white light source) is transmitted directly through substrate 53 in a single pass manner (at grazing incidence), and interacts with the hologram at or near the Bragg angle for the hologram. As the replay beam is diffracted by the transmission hologram, a pixelated light pattern 59 is emitted. As shown, the pixelated light pattern produced from the HLP corresponds to the original mask pattern used during the holographic recording process depicted in FIG. 13. If the original spatial mask has a series of apertures spatially corresponding to the subpixel regions of the monochromatic LCD panel 57 employed in the image display system.

Method for Recording Holograms H1 and H2

In some cases, it may be mechanically or otherwise inconvenient to locate the spatial mask 5 proximate to the holographic recording medium 52 during the recording of the reflection or transmission volume holograms for the HLPs hereof. Thus, in such cases, it may be desirable to use a holographic-type spatial mask “(H1)” in the HLP recording system hereof, such a holographic spatial mask can be made by producing an H1 hologram of a spatial filter (e.g., apertured plate, etc.) and thereafter using the image of the H1 hologram as the object for an H2 hologram. One advantage gained by using an H1 hologram (as a spatial mask), is that one can achieve an HLP having a wider field of view than the HLP produced by the one-step recording system shown in FIGS. 10 and 13 provided, however, that the H1 hologram is significantly larger than the H2.

As shown in FIG. 16, the H1 hologram is made by transmitting the object beam through a spatial mask (e.g., apertured plate) onto the holographic recording medium 30, while the reference beam is transmitted to the recording medium. A lens may be used to image the mask pattern to a spatial location more convenient during the recording process. In a conventional manner, the reference beam interferes with the structured (pixelated) light of the object beam, to form an H1 (transmission-type) hologram using conventional recording techniques.

In FIG. 17, the H1 hologram 30 is used to record a reflection-type edge-lit hologram in a recording medium 39 supported on substrate 36. During the HLP recording process of this alternative embodiment of the present invention, pixelated object beam 38 from hologram H1 interferes with reference beam 37 within recording medium 39, forming a slanted-fringe reflection hologram for a HLP. This is achieved by replaying the H1 hologram so that the image of the mask produced by hologram H1 is used as the object for a second hologram, denoted as H2. Utilizing the H1 hologram recorded with the system of FIG. 16, a replay beam 35 reconstructed with the conjugate of the original reference beam 30, is used to reconstruct the image, 38 of mask 32. Depending on the application, the location of the image is either proximate to, within or somewhat displaced from the H2 hologram recording medium 39, and forms the object beam. Reference beam 37, travels through substrate 36 at a very steep or grazing incidence angle and passes into recording medium 39 and interferes with the object beam. The interference of the reference and object beams cause fringes to form within the holographic medium, which are then fixed to form a hologram. The index matching restrictions and recording geometry of this recording system are similar to those of FIGS. 5a and 5b, and will thus not be repeated here. The pixelated reflection hologram made using the above-described recording system and method can then be used to construct an HLP for incorporation into the monochromatic image display system of the present invention.

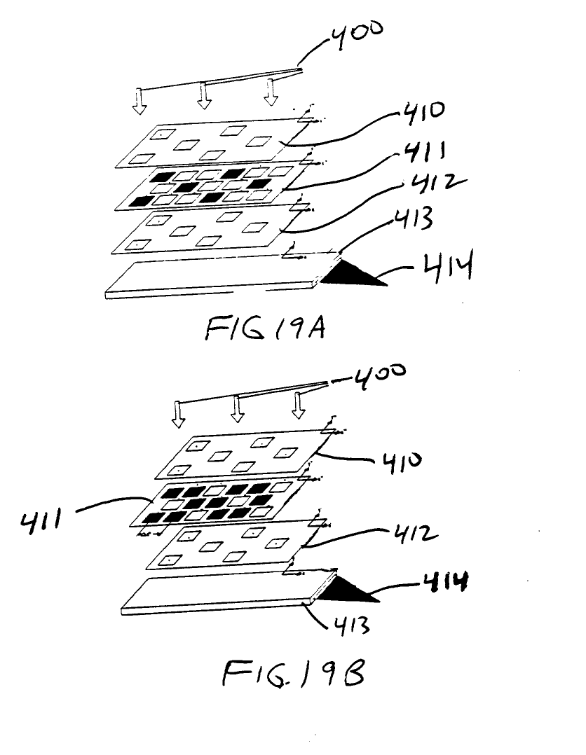

In FIGS. 13B and 18, different systems are shown for recording a transmission version of the hologram recorded using the system of FIG. 13.

In FIG. 18, H1 hologram 361 is replayed by beam 360, to form an image 363 of the original “pixelated” spatial mask. In general, the image 363 may be located within or without the H2 hologram 365. During the recording process, the H2 holographic recording medium 365 has a first surface 366 and a back surface 367, and is mounted on substrate 364, as shown. Reference beam 362 travels through substrate 364 at a very steep or grazing incidence angle, to interfere within recording medium 365 with light from the pixelated image 363 (i.e., object beam). The H2 hologram 365 has a front surface 366 and a back surface 367.

In FIG. 13B, an alternative system is shown for recording the H2 hologram using the image of the H1 hologram as the object for the H2 hologram. In FIGS. 13B and 13B, different systems are shown for recording a transmission version of the hologram recorded using the system of FIG. 13. As shown in FIG. 18, H1 hologram 27 is replayed by beam 250, to form an image 251 of the original “pixelated” spatial mask, which is located within or without the H2 hologram 252 (typically closer to the plane of the recording medium). During the recording process, the H2 holographic recording medium 252 is mounted on substrate 253, as shown. Reference beam 254 travels through substrate 256 at a very steep or grazing incidence angle, to interfere within recording medium 252 with light from the pixelated image 251 (i.e., object beam) to form slanted-fringe pattern, as discussed hereinabove.

Making Pixelated HLPs for Flat Color Display Panels

When making a color flat panel image display system employing active matrix liquid crystal display panel, each pixel region in the color display panel is divided into three subpixels, each subpixel corresponding to the color red (R), blue (B) or green (G), in additive-primary type color systems. In subtractive-primary color systems, the subpixels associated with each pixel in the color display will correspond to yellow (Y), cyan (C) and magenta (M). In the illustrative embodiments, the additive primary color system is employed.

Each subpixel in the HLP of the illustrative embodiment embodies a slanted-fringe volume hologram. The function of each “red” subpixel region in the HLP is to produce spectrally-filtered light within the red spectral band. The function of each “green” subpixel region in the HLP is to produce spectrally-filtered light within the green spectral band. The function of each “blue” subpixel region in the HLP is to produce spectrally-filtered light within the blue spectral band. Collectively, these arrays of microscopic volume reflective holograms provide a system of color generation, operating on principles of diffraction. As this system of color generation does not employ absorptive-type spectral filters, its light transmission efficiency is substantially greater than the light transmission efficiency of prior art absorptive color generation systems, and its manufacturing cost is significantly less.

In order to make the pixelated HLP for this color display system, a spatial mask is used having (subpixel) light transmitting apertures that correspond to the actual subpixel locations of the spatial light modulator (e.g., AMLCD) used in the final color display system under design. In general, since the red green and blue subpixel regions in the monochromatic active matrix LCD are spatially periodic, one mask can be used to record each of the three subpixel patterns within the hologram of the HLP. It is understood however that it will be necessary to register the spatial mask at each stage of the holographic recording process in order to register the subpixel regions of the mask with corresponding subpixel regions in the recording medium that correspond to the subpixel regions along the monochromatic LCD panel, forming the SLM component of the HLP. Alternatively, one can use a different mask to realize a different pattern of mini-holograms corresponding to a particular subpixel color (R,G,B). In either embodiment of the present invention, each of the three subpixel arrays of mini-holograms is spectrally tuned to a different wavelength band (e.g., R, G, or B) corresponding to the color band of light which is to emanate from the spatially-registered subpixel pattern on the monochromatic LCD panel.

System For Recording Pixelated HLPs for Color Display Panels

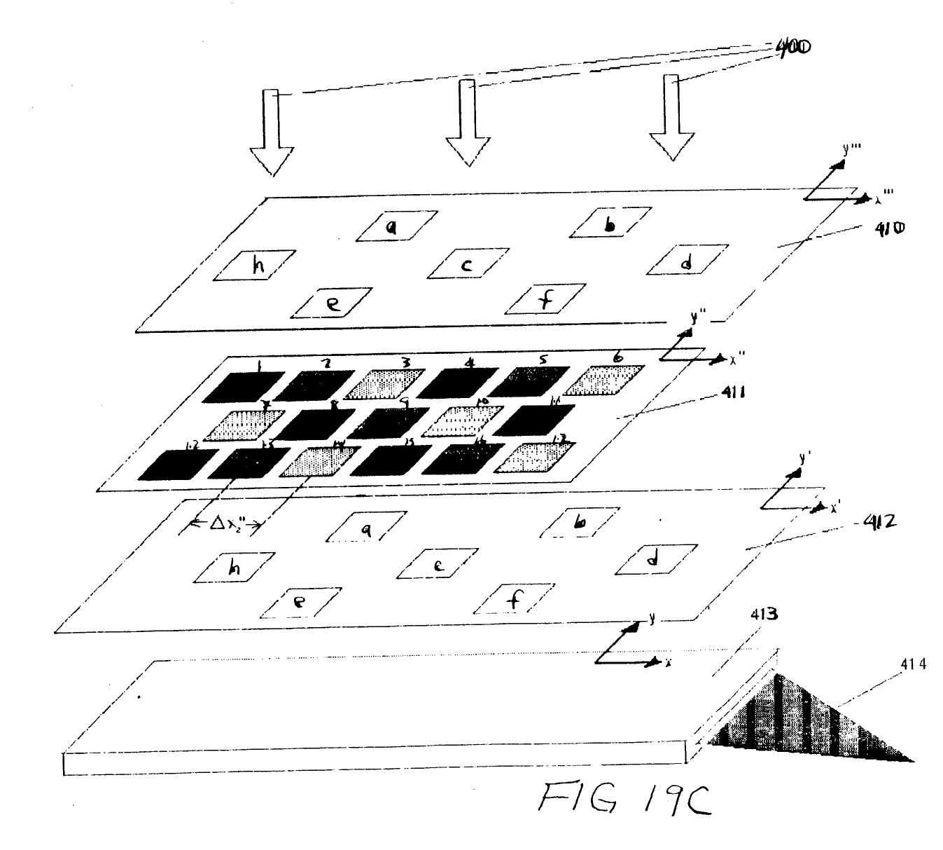

A three color HLP may be constructed using the holographic recording system schematically illustrated in FIGS. 19A through 19C. In the illustrative embodiment, the “RGB” HLP employs a spatial mask or set of spatial masks which allow three (or some other number, depending on the application) discrete sets of volume reflection (or transmission) holograms to be recorded within a single layer of holographic recording medium supported upon an optically transparent substrate 413. In the illustrative embodiment, red, green and blue pixel patterns for a particular flat panel display (to be manufactured) is assumed to be symmetric and spaced apart in such a manner that a single mask 412 can be made to spatially coincide with all of the subpixels of a particular color on the LCD panel. A panchromatic holographic recording medium, such as DuPont HRF705, is supported on the substrate 413. Three laser light sources 414 are provided for producing a red laser beam during the “red” hologram array recording stage, a green laser light beam during the “green” hologram array recording stage, and the blue laser light beam during the blue hologram array recording stage. The red laser light beam can be produced, for example, using the 647 nm line produced from a Krypton laser. The green laser light beam can be produced, for example, using the 532 nm line from a frequency-doubled YAG laser. The blue laser light beam can be produced, for example, using the 441.6 nm line from a Helium-Cadmium laser. Using standard holography techniques, the laser light produced at each primary color recording stage is split into an object beam 400 and a reference beam 414. The reference beam enters transparent substrate 413, for example, travels therethrough at an oblique angle, while the reference beam enters substrate 413, traveling in the −x direction, nearly parallel to the x-y plane, but directed in an upward direction toward mask 412.

During each primary color recording stage, the pixelated spatial mask 412 is translated with respect to the substrate 413 under computer control, for example. During recording of the RED holographic pixel array, the apertures in the spatial mask 412 are aligned with the red subpixels on the monochromatic SLM panel so that only an array of discrete volume holograms tuned to the red spectral band are formed in the holographic recording medium at locations that physically correspond to the red subpixels on the monochromatic SLM panel. During recording of the Green holographic pixel array, the apertures in the spatial mask 412 are aligned with the green subpixels on the monochromatic SLM panel so that only an array of discrete volume holograms tuned to the green spectral band are formed in the holographic recording medium at locations that physically correspond to the green subpixels on the monochromatic SLM panel. During recording of the blue holographic pixel array, the apertures in the spatial mask 412 are aligned with the blue subpixels on the monochromatic SLM panel so that only an array of discrete volume holograms tuned to the blue spectral band are formed in the holographic recording medium at locations that physically correspond to the blue subpixels on the monochromatic SLM panel. During each such recording stage, the reference beam originates from the same location. Depending on the application, and the film and processing technique used, the reference beam angle for each color may have to be adjusted to compensate for chromatic aberrations. After completing the three primary color recording stages, the selectively exposed holographic recording medium (e.g., panachromatic film) is then processed using conventional techniques. When replayed using a white light reconstruction beam, or a light source or sources having discrete red, green and blue spectral emissions, the hologram will emit discrete beams of red, green and blue light spatially corresponding to the red, green and blue subpixel regions of the monochromatic SLM panel. Depending on the pixel or stripe configuration provided by the monochromatic SLM panel to be employed in the flat panel display system under design, three different masks may need to be used, if the pixel spacings differ from color to color for a particular display configuration.

In order to eliminate the problem of multiple exposures of the same region with the reference beam, an additional mask 410, registered to the apertures of mask 412, is placed between the substrate 413 and recording material. During each of the three primary stages of the holographic recording process, the mask 410 is moved to a different registration location for the recording of each array of spectrally-tuned volume holograms.

Preferably, spacial masks 410 and 412 are identical and consist of optically transparent or “open” windows in an opaque material. Such spatial masks can be made by using any one of a number of well known techniques, such as punching holes in a sheet of metal, or, for example, depositing chrome on glass. For an AMLCD illuminator, the hole locations would correspond to all of the subpixel locations for a single color. Mask 410 and mask 412 should be closely index-matched to recording medium 411 according to the index matching principles noted elsewhere herein. Mask 412 should also be index-matched to substrate 413. Typically an index matching fluid would be used for this purpose. If the masks are made on glass, the glass should be of the same material as substrate 413. Each of FIGS. 19A through 19C depict exemplary windows denoted a through f. For clarity, FIG. 19C also includes a window g. Subpixel hologram regions 1 through 17 are shown in holographic recording medium 411. Such material 411 can be any recording material for such purpose capable of low scatter and high diffraction efficiency. Typical examples are holographic recording photopolymers from DuPont or Polaroid Corporation, dichromated gelatin (DCG), or any of numerous other materials used for holographic recording.

Masks 410 and 412 should be mechanically established so that their position with respect to each other remains constant, but can change relative to recording medium 411. Depending on the application, setup, mask type, and recording medium, it may be more desirable to move either the masks or the recording medium, or remove, replace and reposition the masks with respect to the recording medium in between exposures.

A method for recording the RGB-type HLP of the present invention will now be described in detail with reference to the recording system configurations shown in FIGS. 19A, 19B and 19C. The goal of this recording method is to produce an HLP which embodies three discrete subarrays of slanted-fringe volume holograms. Each discrete subarray comprises a set of slanted-fringe volume holograms having a slanted fringe structure that realizes a primary color band-pass filter function that is different for each of the three hologram arrays. As such each discrete hologram array transmits along its first diffractive order, a band of wavelengths corresponding to the primary color assigned to the discrete hologram array.

In the illustrative embodiment, it is assumed that an active matrix liquid crystal display will be used to spatial intensity modulate the discrete set of finely-focused pixelated light beams produced by the HLP. Also a method of recording a three color (RGB) holographic array will be described using a single spatial mask pattern with symmetrically arranged apertures, that is moved under computer control with respect to the holographic recording medium in order that the light transmitting apertures are registered with regions on the recording medium that will spatially correspond with the subpixel regions of the monochromatic SLM panel when the constructed HLP and monochromatic SLM panel are assembled together to produce the final product. It is understood however that some applications may require different masks for each of the different additive primary colors employed in the color system.

In the illustrative example to be described below, masks 410 and 412 are movable in the x direction relative to holographic recording medium 411. However, it is understood that some applications may require motion of the masks in the y and/or x and y directions. Also some applications may require that there is a spacer disposed between mask 410 and recording medium 411 so that upon replay, the image of the “windows” (i.e., light transmitting apertures) in spatial mask 410 fall or otherwise focus precisely within the corresponding subpixel regions of the SLM display panel (e.g., AMLCD). It may also be helpful to laminate or otherwise affix the holographic recording medium 411 to a substrate of the same material as substrate 413 to give it mechanical integrity. During each stage of the multi-stage holographic recording process, the object and reference beams should have the same relative wavefront (or F/#). Also to ensure proper index matching between the substrate and recording medium, it may be desirable to submerge the entire exposure rig in a tank filled with index matching fluid during the recording process. (This technique may be used to realize any embodiment of the present invention).

As shown in FIG. 19A, the first exemplary step of the holographic recording process involves producing a 647 nm spectral line from a Krypton laser source. The laser output is used to produce an object beam 400 which passes through light transmitting apertures a,b,c,d,e and f in spatial mask 410 to illuminate regions 1, 4, 8, 11, 12, and 15 of holographic recording medium 411 from the top side thereof, as shown. The reference beam 414 derived from the same laser source is made to travel through substrate 413 at an oblique angle as noted above. Due to proper index matching conditions, portions of the reference beam will pass through the light transmitting apertures a,b,c,d,e and f of mask 412 to illuminate regions 1, 4, 8, 11, 12 and 15 of recording medium 411 from the bottom side of the recording medium. The object beam and reference beams interfere within holographic recording medium 411 to cause a discrete set of holographic fringe patterns to be formed in regions 1, 4, 8, 11, 12 and 15.

As shown in FIG. 19B, the spatial masks 410 and 412 are moved a distance (x) relative to recording medium 411, or the recording medium 411 is moved a distance −(x) relative to the masks. In either case, the spatial masks and substrate should be larger than the recording region of medium 411 so that only regions desired to be exposed in 411 are indeed exposed. During the second stage of the holographic recording process, the 532 nm line from a frequency doubled Nd-YAG laser is used to form the object and reference beams. During this stage of recording, regions 2, 5, 9, 13 and 16 on holographic recording medium 411 are exposed to cause a discrete set of holographic fringe patterns to be formed in regions 2, 5, 9, 13 and 16.

During the third stage of the holographic recording process, shown in FIG. 19C, spatial masks 410 and 412 are moved a further distance (x₂) relative to recording medium 411. During the second stage of the holographic recording process, the 441.6 nm line from a He-Cd laser is used to produce the object and reference beams. During this stage of the recording process, regions 3, 6, 7, 10, 14 and 17 on the holographic recording medium 411 are exposed to cause a discrete set of holographic fringe patterns to be formed in regions 3, 6, 7, 10, 14 and 17.

After the carrying out the above three stages of exposure, the recording medium 411 is then processed and fixed as a hologram using conventional techniques well known in the art. The hologram is mounted on a substrate for replay using a grazing incidence laser beam produced from either a white light source or a RGB light source at the same location as the recording reference beam.

Having constructed the RGB-type HLP described above, the HLP is then laminated, affixed, adhered or otherwise appropriately arranged with respect to the rear surface of the monochromatic SLM panel, for which the HLP has been designed. Index matching should be taken into consideration when laminating such panels together in order to reduce reflection losses at the hologram-substrate interface. The overall structure, together with the multi-spectral light source and beam shaping optics, can be assembled as an integral unit capable of being mounted within virtually any type of image display housing using techniques well known in the art.

During replay of the RGB-type HLP, a three-color pixelated light pattern will be emitted from the hologram at locations on the surface of the hologram that spatially correspond to the location of corresponding subpixels on the monochromatic SLM panel. In this way, the red subpixelated light pattern is projected through and intensity modulated by the red subpixels of the monochromatic SLM panel; the green subpixelated light pattern is projected through and intensity modulated by the green subpixels of the monochromatic SLM panel; and the blue subpixelated light pattern is projected through and intensity modulated by the blue subpixels of the monochromatic SLM panel. When transmitted through the light intensity modulating subpixel regions on the monochromatic SLM panel, mounted to the HLP, the light projected from these subpixel patterns is spatial intensity modulated in accordance with incoming image display information and the resulting light distribution projected therefrom is fused together on a subpixel-by-subpixel basis, to form the color image to be displayed. Notably, particular color to be imparted by any one pixel in the resulting displayed image is comprised of the light intensity produced from the associated red, green and blue subpixel regions. As light energy absorptive mechanisms are avoided in the color generation method employed in this display system, the light transmission efficiency of the system can be significantly improved over that of prior art systems.

In the above-described embodiment of the RGB HLP hereof, the holograms in each of discrete R, G and B set of holograms have been simultaneously recorded within the recording medium during a single recording stage. It is contemplated, however, that the reference and/or object beam used to form such holograms can be focused down to the size of each subpixel, and scanned (e.g., according to a raster pattern) in order to expose each subpixel location within the recording medium, one at a time. The light beam(s) could be modulated during scanning using techniques (e.g., acousto-optic modulators) well known in the laser scanning industry, so that, for example, a red subpixel region along the holographic recording medium is not exposed by a laser beam used to form a blue subpixel region therein.

In the illustrative embodiment of the RGB-type HLP described above, the holograms in each discrete set thereof are recorded in a single layer of panchromatic film. One alternative method would involve recording discrete sets of hologram associated with two subpixel color patterns of the RGB HLP in a first layer of recording medium (e.g., in solid or liquid phase), while the third discrete set of hologram associated with the third subpixel color pattern is recorded in a separate layer of recording medium. Once recorded, these layers can then aligned or registered with respect to each other, and then held in place using lamination or other techniques known in the art.

An alternative method for making the RGB HLP hereof involves separately recording three discrete sets of holograms spectrally-tuned to the additive primary colors red, green, and blue on three separate layers of holographic recording medium during three recording stages. Thereafter, these three layers are aligned and fixed into place with respect to one another so that the red, green and blue subpixel regions thereof are in proper spatial relationship to each other and in registration with the corresponding subpixel regions along the monochromatic SLM panel for which the HLP is being designed. These aligned layers can be laminated or otherwise mechanically and optically coupled together, or to spacers disposed between each layer, or by mechanically framing or fixturing each layer in such a way that the subpixel patterns of each layer are properly aligned. The stack of pixelated holograms layers are then mounted to a substrate as described hereinabove to produce an RGB-type HLP of composite construction.

Method of Converting to an Edge-Lit HLP to a Face-Lit HLP

Various techniques have been described above for constructing edge-lit HLPs, for example, for use with both monochromatic and color flat panel image display systems. However, there will be some applications where the amount of light required to illuminate an object (e.g., SLM panel, film structure or transparency, etc.) is more than can be easily transmitted through the substrate edge of an edge-lit HLP without resorting to higher power lamps or inconvenient light preconditioning optical schemes that can add unwanted volume to the system packaging. Thus in some cases it is will be desirable to replay the HLP hologram using a light beam that is forced to enter the face of the substrate or the recording medium, at a steep angle, but not with the grazing incidence associated with an edge-lit or substrate guided system. While this illumination technique increases thickness of the overall system packaging, this drawback may be an acceptable trade-off in some instances in order to provide more light for illuminating the HLP hologram during its replay mode.

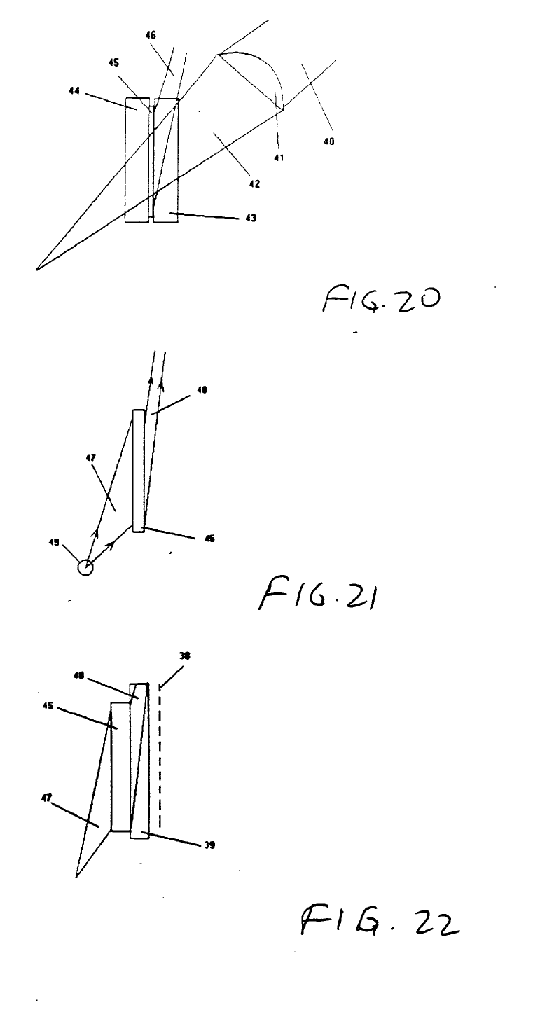

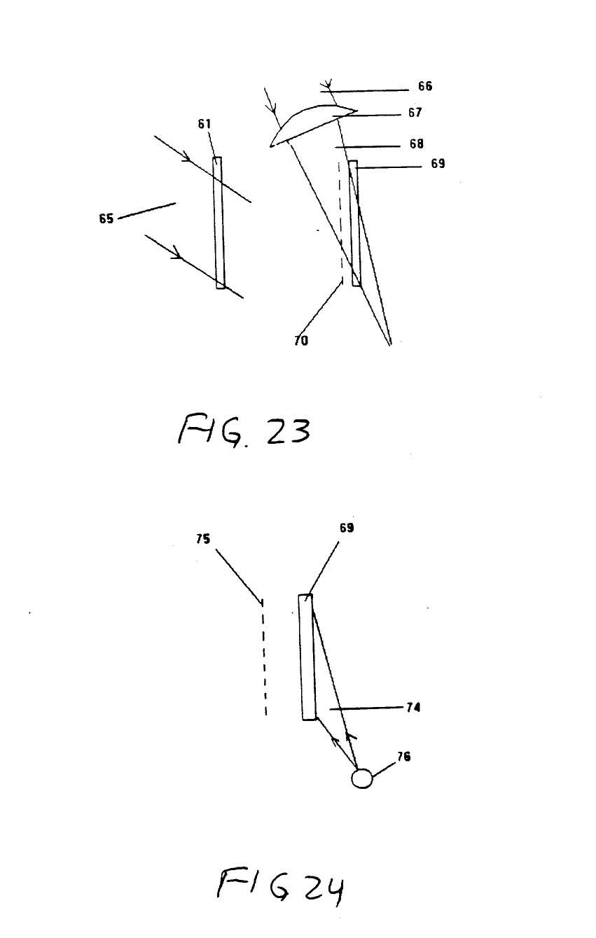

In accordance with an alternative method of HLP hologram recording, an original H1 hologram is first made using the recording system shown in FIG. 16 described above, and then, the image from the H1 hologram is used as the object beam to make a (reflection or transmission type) H2 hologram using the recording system shown in FIGS. 17 or 18 described hereinabove above. Thereafter, a third hologram H3 is made using the recording system shown in FIG. 20. Then as shown in FIG. 22, this H3 hologram is used to reconvert an edge-lit HLP system to a face-lit HLP system by allowing an external (face lit) replay beam to be used. This technique makes more efficient use of replay illumination, yet still maintains the functional benefits of the H2 based grazing incidence or edge-lit system (e.g., produce monochrome color or a set of discrete monochrome color bands from a transmission-type HLP system). The details for making a H3 hologram for use in this type of HLP will be described below.

In FIG. 20, a method is described for creating a steep external reference hologram H3 for illuminating grazing incidence hologram H2 recorded using the system of FIGS. 13B, 17, or 18. As shown in FIG. 20, the object beam 46 (which will later function as the replay beam for hologram H2) is made to travel through substrate 43 at grazing incidence, and pass into H3 holographic recording medium 45 by virtue of the ultra-high optical coupling achieved by optimally matching the refractive index of the substrate and recording medium as described hereinabove (e.g., using BK10 glass as a substrate in combination with DuPont holographic recording film 352). External reference beam 40, in the form of the conjugate of the final replay beam, passes through the external face of substrate 43, through substrate 43 and into recording medium 45 to interfere with object beam 46, creating a fringe pattern therewithin which is subsequently fixed via processing. If the final replay beam is desired to be a point source, then reference beam 40 is passed through a converging lens 41 to form the conjugate 42 (within acceptable aberrational limits) of the final replay beam. Recording medium 45 may be backed by an absorbing material 44 such as black glass to eliminate stray reflections.

In FIG. 21, the replay-mode of the processed H3 hologram 45 is illustrated. Notably, however, the substrate upon which the hologram is mounted is not shown for illustration purposes. As shown, a point source 49 (e.g., a small filament white light lamp) is used to produce a reconstruction beam 47 which illuminates hologram 45. In response, light beam 48 is emitted from hologram 45 at a near grazing angle. As will be illustrated in FIG. 22, light beam 48 is used as the replay beam for hologram H2.

Once constructed, the H3 hologram is affixed to the H2 hologram or an appropriate substrate therebetween as shown in FIG. 22., thus recreating the conjugate reference for H2 using H3. Notably, an advantage of using the system configuration is that the H3 hologram is illuminated over its large (sur)face area.

In FIG. 22, the complete replay assembly is conceptually shown. For purposes of illustration, the substrates used in this replay system are not shown. During replay mode, the replay beam 47 illuminates H3 hologram 47, which emits a light beam 48 that is used as the replay beam for H2 hologram 39. A pixelated light pattern 38 (e.g., comprising a periodic array of color light beams) is emitted from hologram 39. Because of the large replay angles involved, the regenerated edge reference from H3 is monochrome but matches the monochrome edge reference requirement on conjugate replay of H2. Thus H2 replays in monochrome. This is as opposed to traditional transmission holographic systems which typically disperse white light into a rainbow of colors.

While the above-described conversion method has been illustrated in connection with an edge-lit reflection-type HLP, the method can be readily used to convert an edge-lit transmission-type HLP into a face-lit transmission type HLP.

Method and System for Making a White-Light Emitting HLP

In some applications (e.g., image illumination or display systems), it would be advantageous for an HLP to emit a pixelated pattern perceived as “white” pixels, rather than a subpixel pattern of red, green and blue light required in color display systems. Below will be described a method of creating an HLP capable of emitting white light pixel patterns.

According to this method, an H1 hologram is first made using the recording system shown in FIG. 16 and described above. Then an H2 hologram is made using the recording system shown in FIG. 23. Depending on application requirements, the H2 hologram may be made as either a transmission type volume hologram or as a reflection type volume hologram. As shown in FIG. 23, a steep reference angle transmission H2 hologram (i.e., measured external to the substrate) is shown being recorded. During the recording process, the replay beam 65, which is conjugate to the original reference beam 30 in FIG. 16, is used to illuminate hologram 61, (the same as 30 in FIG. 16), thereby reconstructing the image 70 of original spatial mask 32. Image 70 serves as the object during the creation of H2 hologram 69. As shown in FIG. 23, new reference beam 68 is produced and caused to impinge on the H2 recording medium 69, interfering with the object beam containing image 70 and causing a set of interference fringes to be formed within recording medium 69. Using conventional techniques, these interference fringes are then fixed to form the final H2 hologram. Then H2 hologram is mounted to a proper substrate and provided with a light source (and associated optics) 76 to produce an assembled HLP.

As shown in FIG. 24, the recorded hologram 69 within the assembled HLP is replayed using illumination beam 74 produced from light source (and associated optics) 76. Illumination beam 74 forms the conjugate of original reference beam 68, and reconstructs a real image 75 of spatial mask 32. One of the advantages of such a light transmission system is that, if for example the spatial mask was realized as a series of holes, or pixelated light transmitting apertures, then the hologram employed in this particular embodiment will produce white spots of light.

Notably, in the HLP embodiment shown in FIG. 23, the design specifications called for the final replay beam to be diverging, and thus to achieve this replay condition, the reference beam 68 is shown as converging (having originated from beam 66 and passing through lens 67) during the holographic recording process shown in FIG. 23. It is to be understood, however, that the reference beams and their associated conjugate replay beams are not limited to the converging reference/diverging replay system as shown, but may be collimated, or otherwise shaped, depending on the application at hand. Also while the system of FIG. 23 is shown being used to record a transmission H2, it is understood that this system can be readily reconfigured so that the reference beam 68 is caused to impinge on the holographic recording medium 69 from the opposite side as the object beam, and thus form a reflection hologram version of the HLP illuminator described above.

While the particular illustrative embodiments shown and described above will be useful in many applications in back and front lighting art not limited to the use of SIMs, further modifications to the present invention herein disclosed will occur to persons with ordinary skill in the art. All such modifications are deemed to be within the scope and spirit of the present invention defined by the appended Claims to Invention.

What is claimed is:

1. An illumination panel for illuminating an object, comprising:
a substrate made from an optically transparent material, having first and second areal surfaces disposed substantially parallel to each other and a light input surface for conducting a light beam into said substrate;
a light diffractive grating mounted to said first areal surface of said substrate and having a slanted fringe structure embodied therein for diffracting said light beam falling incident thereto, along a first diffractive order of said slanted fringe structure; and
a light source for producing a light beam for transmission through said input surface and direct passage through said substrate to said slanted fringe structure so as to produce an output light beam of areal extent that emerges from either said first or second areal surface along said first diffractive order, for use in illuminating an object.

2. The illumination panel of claim 1, wherein said light diffractive grating is a volume hologram.

3. The illumination panel of claim 2, wherein said slanted fringes have an angle of slant from about 35 to about 55 degrees measured with respect to said first and second areal surfaces.

4. The illumination panel of claim 2, wherein said volume hologram is a reflection-type volume hologram affixed to said second areal surface of said substrate.

5. The illumination panel of claim 3, wherein said reflective-type volume hologram embodies a slanted fringe-pattern that produces a plane of light having a substantially uniform spatial intensity distributed over a substantial portion of said first areal surface.

6. The illumination panel of claim 4, wherein said reflection-type volume hologram embodies a slanted fringe-pattern that produces a plane of light having a pixelated spatial intensity distributed over a substantial portion of said first areal surface.

7. The illumination panel of claim 1, which further comprises
a light diffusing panel for diffusing light produced from said first surface of said reflection-type volume hologram.

8. The illumination panel of claim 4, wherein said reflective-type volume hologram comprises an array of spectrally-tuned reflection-type volume holograms.

9. The illumination panel of claim 6, wherein said array of spectrally-tuned reflection-type volume holograms comprises a first subarray of reflection-type volume holograms spectrally-tuned to the color red, a second subarray of reflection-type volume holograms spectrally-tuned to the color green, and a third subarray of reflection-type volume holograms spectrally-tuned to the color blue.

10. The illumination panel of claim 2, wherein said substrate has an end surface and said input surface is said edge surface.

11. The illumination panel of claim 10, wherein said input surface is said first or second areal surface.

12. The illumination panel of claim 11, which further comprises light diffractive means for coupling said light into said input surface.

13. The illumination panel of claim 2, wherein said volume hologram is a transmission-type volume hologram affixed to said first areal surface of said substrate.

14. The illumination panel of claim 13, wherein said transmission-type volume hologram embodies a slanted fringe-pattern that produces a plane of light having a substantially uniform spatial intensity distributed over a substantial portion of said second areal surface.

15. The illumination panel of claim 13, wherein said transmission-type volume hologram embodies a slanted fringe-pattern that produces a plane of light having a pixelated spatial intensity distributed over a substantial portion of said first areal surface.

16. The illumination panel of claim 13, which further comprises
a light diffusing panel for diffusing light produced from said first surface of said transmission-type volume hologram.

17. The illumination panel of claim 13, wherein said transmission-type volume hologram comprises an array of spectrally-tuned transmission-type volume holograms.

18. The illumination panel of claim 17, wherein said array of spectrally-tuned transmission-type volume holograms comprises a first subarray of transmission-type volume holograms spectrally-tuned to the color red, a second subarray of transmission-type volume holograms spectrally-tuned to the color green, and a third subarray of transmission-type volume holograms spectrally-tuned to the color blue.

19. An image display panel for displaying images, comprising:
a substrate made from an optically transparent material, having a first and second areal surfaces disposed substantially parallel to each other and a light input surface for conducting a light beam into said substrate;
a light diffractive grating mounted to said first areal surface of said substrate and having a slanted fringe structure embodied therein for diffracting said light beam falling incident thereto, along a first diffractive order of said slanted fringe structure;
a spatial intensity modulation panel arranged with said substrate and volume hologram, for modulating the spatial intensity of light transmitted through said spatial intensity modulation panel and forming an image for display; and
a light source for producing a light beam for transmission through said input surface and direct through said substrate to said slanted fringe structure so as to produce an output light beam of areal extent that emerges from either said first or second areal surface along said first diffractive order, for use in illuminating said spatial intensity modulation panel and forming said image for display.

20. The image display panel of claim 19, wherein said light diffractive grating is a volume hologram.

21. The image display panel of claim 19, wherein said slanted fringes have an angle of slant from about 35 to about 55 degrees measured with respect to said first and second areal surfaces.

22. The image display panel of claim 20, wherein said volume hologram is a reflection-type volume hologram affixed to said second areal surface of said substrate.

23. The image display panel of claim 22, wherein said reflective-type volume hologram embodies a slanted fringe-pattern that produces a plane of light having a substantially uniform spatial intensity distributed over a substantial portion of said first areal surface.

24. The image display panel of claim 23, wherein said reflection-type volume hologram embodies a slanted fringe-pattern that produces a plane of light having a pixelated spatial intensity distributed over a substantial portion of said first areal surface.

25. The image display panel of claim 19, which further comprises
a light diffusing panel for diffusing light produced from said light diffractive grating.

26. The image display panel of claim 22, wherein said reflective-type volume hologram comprises an array of spectrally-tuned reflection-type volume holograms.

27. The image display panel of claim 26, wherein said array of spectrally-tuned reflection-type volume holograms comprises a first subarray of reflection-type volume holograms spectrally-tuned to the color red, a second subarray of reflection-type volume holograms spectrally-tuned to the color green, and a third subarray of reflection-type volume holograms spectrally-tuned to the color blue.

28. The image display panel of claim 19, wherein said substrate has an end surface and said input surface is said edge surface.

29. The image display panel of claim 19, wherein said input surface is said first or second areal surface.

30. The image display panel of claim 29, which further comprises light diffractive means for coupling said light into said input surface.

31. The image display panel of claim 20, wherein said volume hologram is a transmission-type volume hologram affixed to said first areal surface of said substrate.

32. The image display panel of claim 31, wherein said transmission-type volume hologram embodies a slanted fringe-pattern that produces a plane of light having a substantially uniform spatial intensity distributed over a substantial portion of said second areal surface.

33. The image display panel of claim 31, wherein said transmission-type volume hologram embodies a slanted fringe-pattern that produces a plane of light having a pixelated spatial intensity distributed over a substantial portion of said first areal surface.

34. The image display panel of claim 31, which further comprises a light diffusing panel for diffusing light produced from said first surface of said transmission-type volume hologram.

35. The image display panel of claim 31, wherein said transmission-type volume hologram comprises an array of spectrally-tuned transmission-type volume holograms.

36. The image display panel of claim 35, wherein said array of spectrally-tuned transmission-type volume holograms comprises a first subarray of transmission-type volume holograms spectrally-tuned to the color red, a second subarray of transmission-type volume holograms spectrally-tuned to the color green, and a third subarray of transmission-type volume holograms spectrally-tuned to the color blue.

37. A computer system including said image display panel of claim 19.

38. A method of making an illumination panel for illuminating an object, comprising the steps:
(a) providing a substrate made from an optically transparent material, having first and second areal surfaces disposed substantially parallel to each other and a light input surface for conducting a light beam into said substrate;
(b) mounting a light diffractive grating to said first areal surface of said substrate and having a slanted fringe structure embodied therein for diffracting said light beam falling incident thereto and along a first diffractive order of said slanted fringe structure; and
(c) assembling a light source with said substrate, for producing a light beam for transmission through said input surface and direct passage through said substrate to a said slanted fringe structure so as to produce an output light beam of areal extent that emerges from either said first or second areal surface along said first diffractive order, for use in illuminating an object.

39. A method of making a pixelated illumination panel comprising the steps:
(a) providing a recording medium;
(b) exposing said recording medium to light so as to form therewithin, an array of spectrally-tuned volume holograms spectrally-tuned to the colors red, green and blue.

40. A system of making a pixelated illumination panel comprising the steps:
means for supporting a recording medium; and
means for selectively exposing said recording medium to light so as to form therewithin, an array of spectrally-tuned volume holograms spectrally-tuned to the colors red, green and blue.

41. A method of making a pixelated illumination panel comprising the steps:
(a) providing a recording medium;
(b) exposing said recording medium to light so as to form therewithin, an array of broad-band volume holograms which produce white light.

42. A system of making a pixelated illumination panel comprising the steps:
means for supporting a recording medium; and
means for selectively exposing said recording medium to light so as to form therewithin, an array of broad-band volume holograms which produce white light.

43. A method of making an illumination panel comprising the steps:
(a) providing a recording medium;
(b) exposing said recording medium to light so as to form therewithin, a volume hologram panel for producing white light.

44. A system of making an illumination panel comprising the steps:
means for supporting a recording medium; and
means for selectively exposing said recording medium to light so as to form therewithin, a volume hologram panel for producing white light.
